(19) United States
(12) Patent Application Publication
(10) Pub. No.: US 2026/0180689 A1
(43) Pub. Date: Jun. 25, 2026

(54) SYMBOL DETERMINATION APPARATUS, SYMBOL DETERMINATION METHOD AND PROGRAM

(71) Applicant: NTT, Inc., Tokyo (JP)

(72) Inventors: Hiroki TANIGUCHI, Musashino-shi (JP); Shuto YAMAMOTO, Musashino-shi (JP); Akira MASUDA, Musashino-shi (JP); Yoshiaki KISAKA, Musashino-shi (JP)

(73) Assignee: NTT, Inc., Tokyo (JP)

(21) Appl. No.: 18/832,342

(22) PCT Filed: Jan. 27, 2022
(86) PCT No.: PCT/JP2022/003121

§ 371 Date: Jul. 23, 2024

(51) Int. Cl. H04B 10/69; H04B 10/516

(52) U.S. Cl. CPC H04B 10/69; H04B 10/516

(57) ABSTRACT

Generating a plurality of possibility symbol sequences that is a possibility for a transmission signal sequence formed by a transmission symbol; outputting an estimated reception symbol obtained as an output when each of a plurality of the possibility symbol sequences generated is given, as an input sequence, to the function approximator that approximates a transfer function of a transmission path that transmits the transmission signal sequence; specifying an estimated transmission symbol corresponding to a determination target reception symbol sequence by determining the transmission symbol by maximum likelihood sequence estimation on the basis of the determination target reception symbol sequence obtained from a reception signal sequence when the transmission path transmits the transmission signal sequence and the estimated reception symbol for each possibility symbol sequence; and optimizing the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

### TECHNICAL FIELD

The present invention relates to a symbol determination apparatus, a symbol determination method, and a program.

### BACKGROUND ART

In recent years, traffic transferred by a backbone network of the Internet continues to increase due to rapid spread of smartphones and tablets, an increase in rich content such as high-definition video distribution services, and the like. Utilization of cloud services in companies has also been progressing. From these, it is predicted that the traffic of the network within a data center (hereinafter referred to as “DC”) and between the DCs increases at a rate of about 1.3 times a year.

Currently, Ethernet (registered trademark) is mainly introduced as a connection method within a DC or between DCs. With an increase in communication traffic, it is expected that it is difficult to increase the scale of a DC in a single base. Therefore, in the future, the need for cooperation between DCs will increase more than ever, and the traffic transmitted and received between DCs will further increase. In order to cope with such a situation, establishment of a low-cost and large-capacity short-range optical transmission technology is required.

In the current Ethernet (registered trademark) standard, optical fiber communication is applied to a transmission path up to 40 km except 10 Gigabit Ethernet (GbE) (registered trademark)-ZR. An intensity modulation method that allocates binary information to on and off of light is used up to 100 GbE. The reception side includes only a light receiver, and is configured to be less expensive than a coherent reception method used in long-distance transmission.

In 100 GbE, a transmission capacity of 100 Gigabit per second (Gbps) is achieved by 4-wave multiplexing of a non-return-to-zero (NRZ) signal having a modulation speed of 25 GigaBaud (GBd) and an information amount per symbol of 1 bit/symbol.

In the standardization of 400 GbE, which is the next generation of 100 GbE, 4-level pulse-amplitude-modulation (PAM4) of 2 bits/symbol is adopted for the first time in consideration of maintenance of an economical device configuration used in 100 GbE and band utilization efficiency of a signal. As a result, a transmission capacity of 400 Gbps is achieved by 4-wave multiplexing a PAM4 signal of 100 Gbps. Examples of the standard of 400 GbE include 400GBASE-FR4, LR4. In recent years, standardization of 800 GbE and 1.6 TbE is scheduled for further increasing traffic in the future. These communication speeds are expected to be achieved by, for example, 4- to 8-wave multiplexing of a 200 Gbps signal having a modulation speed of 100 GBaud by employing PAM4.

As a problem in further increasing the capacity, it is assumed that the effect of band limitation and wavelength dispersion of the device becomes apparent as the transmission capacity increases, and signal quality degradation increases. For example, as illustrated in FIG. 24, when the transmission capacity increases and the use band increases, there arises a problem that a frequency region 601 (hatched region with oblique lines) is lost due to the band limitation of the device. As illustrated in FIG. 25, when the transmission capacity increases, the effect of wavelength dispersion increases, and an interference region 602 increases.

As a method of solving such a problem, there is a method of using a digital-to-analog converter (DAC) or an analog-to-digital converter (ADC) compatible with a high communication speed, or using a dispersion compensation module or the like that compensates for dispersion of wavelengths. However, such equipment is expensive, and the cost required for the equipment increases, and thus, from the economic viewpoint, it is a method that is desired to be refrained from being adopted. From the economic viewpoint, a desired method is a method of improving multivalue, band limitation tolerance, and wavelength dispersion tolerance while maintaining the configuration of a conventional transceiver, and utilizing a low-cost narrowband device.

However, when a low-cost narrowband device is used, for example, a driver or a light receiver has a nonlinear input/output characteristic as illustrated in FIG. 26, and a modulator also has a nonlinear input/output characteristic as illustrated in FIG. 27. Therefore, there is a problem that nonlinear waveform distortion occurs. In the case of using the direct detection method, nonlinear loss characteristics as illustrated in FIG. 28 occur in a frequency region due to the interaction between wavelength dispersion and square-law detection. That is, in a case where a low-cost narrowband device is used, since there is nonlinear response characteristics as described above, the device is affected by the nonlinear response characteristics in addition to the intersymbol interference due to the band limitation and the wavelength dispersion accompanying an increase in the communication speed. Therefore, the conventional linear equalization or estimation method has a problem that it is difficult to obtain correct transmission data.

This problem will be specifically described with reference to FIGS. 29 and 30. FIG. 29 is a block diagram illustrating a conventional communication system 100 configured using the above-described low-cost narrowband device. The communication system 100 includes a signal generation apparatus 3 on the transmission side, a transmission path 2, and an identification apparatus 4z on the reception side.

The signal generation apparatus 3 fetches an m-value data sequence given from the outside, and generates a transmission symbol sequence formed by arranging transmission symbols of digital electric signals in time series, that is, a transmission signal sequence {sₜ}. Here, m is a symbol multivalue degree and is an integer of 2 or more. Each of the transmission symbols included in the transmission signal sequence {sₜ} indicated by a number or a symbol. For example, when PAM8 is employed and m=8, each of the transmission symbols is indicated by a number [0, 1, 2, 3, 4, 5, 6, 7]. t is an identification number for identifying each of the transmission symbols included in the transmission signal sequence {sₜ}, and indicates a relative time at which each of the transmission symbols is generated. For example, in a case where the transmission signal sequence {sₜ} is transmitted in units of blocks, when the number of transmission symbols of the transmission signal sequence {sₜ} included in one block is N, t=1, 2, . . . , N−1, and N.

In the transmission path 2, an intensity modulator 2-2 fetches the transmission signal sequence {sₜ} of a digital electric signal output by the signal generation apparatus 3. The intensity modulator 2-2 performs intensity modulation on the light emitted from a light source 2-1 by the fetched transmission signal sequence {s_{L}} of the digital electric signal, and generates a transmission signal sequence {sₜ} of an optical signal. An optical fiber 2-3 transmits the transmission signal sequence {sₜ} of the optical signal generated by the intensity modulator 2-2. A light receiver 2-4 receives the transmission signal sequence {sₜ} of the optical signal transmitted by the optical fiber 2-3 as a reception signal sequence {rₜ} of the optical signal, converts the transmission signal sequence {sₜ} into the reception signal sequence {rₜ} of an analog electric signal by the direct detection method, and outputs the reception signal sequence {rₜ}. The light receiver 2-4 is, for example, a photodiode.

The identification apparatus 4z includes a reception unit 5, a symbol determination unit 90, and a demodulation unit 7. The reception unit 5 performs preprocessing such as conversion of the reception signal sequence {rₜ} of the analog electric signal output from the light receiver 2-4 into a reception signal sequence {rₜ} of a digital electric signal, and outputs the reception signal sequence {rₜ} of the digital electric signal obtained by the preprocessing to the symbol determination unit 90. The symbol determination unit 90 determines a transmission symbol with respect to the reception signal sequence {rₜ} to specify and output an estimated value of the transmission symbol (hereinafter referred to as “estimated transmission symbol”). The demodulation unit 7 restores and outputs an m-value data sequence from an estimated transmission signal sequence formed from the estimated transmission symbol output by the symbol determination unit 90.

At this time, when the transmission path 2 is indicated by an equalization circuit, a configuration as illustrated in FIG. 30 is obtained. FIG. 30 illustrates a configuration in which an L symbol before and an L symbol after a symbol at time t of the transmission signal sequence {sₜ} of light are given to a transfer function unit 83 on the assumption that the intersymbol interference occurs up to the symbols separated by L symbols before and after the symbol at time t in the transmission path 2.

A delayer 81 fetches and stores the transmission symbol included in the transmission signal sequence {sₜ}, and outputs the stored transmission symbol after the lapse of time of “−LT”. Note that since the delay amount has a minus symbol, the delayer 81 gives a negative delay of “LT”. Here, “T” is a symbol interval, and the timing of calculation for each symbol is “tT”.

Each of delayers 82-1 to 82-2L fetches and stores the transmission symbol output from a previous delayer 81 and 82-1 to 82-(2L−1) connected thereto, and outputs the stored transmission symbol after the lapse of time of “T”.

The transfer function unit 83 applies a transfer function (H) to the symbol sequence output from the delayers 81 and 82-1 to 82-2L. An adder 85 adds cot, which is a noise component, to an output value of the transfer function unit 83 to generate the reception signal sequence {rₜ}. ωₜ is a Gaussian random sequence independent of each other with an average of 0 and a variance δ². The reception signal sequence {rₜ} generated by the equalization circuit in FIG. 30 is, when indicated by a formula, indicated by Formula (1) described below.

$$\begin{matrix}[ Math . 1 ] & \\ {r}_{t} = H ( {s}_{t - L} , … , {s}_{t} , … , {s}_{t + L} ) + {ω}_{t} & ( 1 )\end{matrix}$$

As can be seen from Formula (1), when cot can be removed and the correct transfer function (H) can be calculated in the symbol determination unit 90, the original transmission signal sequence {sₜ} can be restored using the inverse function of the calculated transfer function (H).

However, when there are problems of intersymbol interference and nonlinear response as described above, it is difficult to calculate an accurate transfer function (H). As an effective equalization method for obtaining correct transmission data from a reception signal waveform distorted by intersymbol interference or nonlinear response, for example, an equalization method called maximum likelihood sequential estimation (hereinafter, “MLSE”) is known (see, for example, Non Patent Literatures 1, 2, 3, and 4).

Here, an outline of the MLSE method will be described. The MLSE method is a method of estimating a most likely transmission symbol corresponding to the reception signal sequence {rₜ} by applying the estimated transfer function (hereinafter, referred to as an “estimated transfer function (H′)) to all the transmission signal sequences {sₜ} and comparing the output sequence with the reception signal sequence {rₜ}. However, when a sequence length N of the symbols of the transmission signal sequence {sₜ} and the reception signal sequence {rₜ} increases, the calculation amount for comparison becomes enormous.

Therefore, in the MLSE method, a method of performing comparison while limiting the length of the sequence, that is, a method of determining the transmission symbol by searching for a transmission signal sequence {s′ₜ} that maximizes a conditional joint probability density function p_{N} ({r_{N}}{s′_{N}}) indicated by Formula (2) described below is used.

$$\begin{matrix}[ Math . 2 ] & \\ {p}_{N} ( \{ {r}_{N} \} \vert \{ {s}_{N}^{′} \} ) = \frac{1}{{( 2 {πδ}^{2} )}^{N}} exp [ - \frac{1}{2 {δ}^{2}} {\sum }_{t = 1}^{N} {\vert {r}_{t} - {H}^{′} ( {{s}^{′}}_{t - L} , … , {{s}^{′}}_{t} , … , {{s}^{′}}_{t + L} ) \vert}^{2} ] & ( 2 )\end{matrix}$$

The conditional joint probability density function p_{N} ({r_{N}}{s′_{N}}) indicates a probability that the reception signal sequence {rₜ} will be received when the transmission signal sequence {s′ₜ} having a sequence length N generated from an m-value data sequence is transmitted through the transmission path 2. As can be seen from Formula (2), the sequence length of the transmission signal sequence {s′ₜ} corresponding to one t is not “N”, but is limited to “2L+1”.

Maximizing the conditional joint probability density function p_{N} ({r_{N}}{s′_{N}}) is equivalent to minimizing a distance function d_{N} indicated by Formula (3) described below. Note that, in Formula (3), the substitution with (p−1)/2=L is performed. Since L is an integer of l or more, p is an odd integer of 3 or more.

$$\begin{matrix}[ Math . 3 ] & \\ {d}_{N} = {\sum }_{t = 1}^{N} {\vert {r}_{t} - {H}^{′} ( {{s}^{′}}_{t - ( p - 1 ) / 2} , … , {{s}^{′}}_{t} , … , {{s}^{′}}_{t + ( p - 1 ) / 2} ) \vert}^{2} & ( 3 )\end{matrix}$$

(s′_{t-(p-1)/2}, . . . , s′ₜ, . . . , s′_{t+(p-1)/2}) in Formula (3) indicates state t (hereinafter, “transmission path state μₜ”) of the transmission path 2 at time t. When the sequence length is “p”, the number of all combinations of modulation symbol l=[i₁, i₂, . . . , iₘ] is “m^{p}”. In this case, the transmission path 2 can be regarded as a finite state machine having m^{p} finite transmission path states. Therefore, for example, the distance function d_{N} can be calculated by performing sequential calculation for each reception signal sequence {rₜ} using the Viterbi algorithm or the like.

A distance function dₜ ({μₜ}) reaching the transmission path state μₜ at time t is indicated by Formula (4) described below using a distance function dₜ₋₁ ({μₜ₋₁}) at time t−1 and the likelihood associated with the state transition at time t, that is, a metric b (rₜ; μₜ₋₁→μₜ).

$$\begin{matrix}[ Math . 4 ] & \\ {d}_{t} ( \{ {μ}_{t} \} ) = {d}_{t - 1} ( \{ {μ}_{t - 1} \} ) + b ( {r}_{t} ; {μ}_{t - 1} \to {μ}_{t} ) & ( 4 )\end{matrix}$$

The metric b (rₜ; μₜ₋₁→μₜ) is indicated by Formula (5) described below using the estimated transfer function (H′).

$$\begin{matrix}[ Math . 5 ] & \\ b ( {r}_{t} ; {μ}_{t - 1} \to {μ}_{t} ) = {\vert {r}_{t} - {H}^{′} ( {{s}^{′}}_{t - ( p - 1 ) / 2} , … , {{s}^{′}}_{t} , … , {{s}^{′}}_{t + ( p - 1 ) / 2} ) \vert}^{2} & ( 5 )\end{matrix}$$

The metric b at time t depends only on the state transition from t−1 to t and do not depend on previous state transitions. Here, it is assumed that a minimum value d_minₜ₋₁ (μₜ₋₁) of the distance function reaching the transmission path state μₜ and the corresponding all state transitions are known in all the transmission path states μₜ₋₁ at time t−1.

Under this assumption, when the minimum value of a distance function dₜ ({μₜ}) reaching the transmission path state pt is obtained, it is not necessary to obtain the distance function dₜ ({μₜ}) corresponding to all the state transitions. For all transmission path states {μₜ₋₁} that may transition to the transmission path state μₜ, d_minₜ₋₁ (μₜ₋₁)+b (rₜ; μₜ₋₁→μₜ) is calculated, and a minimum value thereof is obtained, and the value becomes d_minₜ (μₜ) that is a minimum value of all distance functions dₜ ({μₜ}) reaching the transmission path state μₜ. This, when indicated by a formula, is indicated by Formula (6) described below.

$$\begin{matrix}[ Math . 6 ] & \\ {d\_min}_{t} ( {μ}_{t} ) = {min}_{\{ {μ}_{t - 1} \} \to {μ}_{t}} \{ {d\_min}_{t - 1} ( {μ}_{t - 1} ) + b ( {r}_{t} ; {μ}_{t - 1} \to {μ}_{t} ) \} & ( 6 )\end{matrix}$$

As a method of obtaining the minimum value of the distance function dₜ ({μₜ}) reaching the transmission path state μₜ as described above, for example, there is a method such as the Viterbi algorithm. By using such a method, without calculating the distance function dₜ ({μₜ}) corresponding to all the state transitions, for all transmission path states {μₜ₋₁} that may transition to the transmission path state μₜ, d_minₜ₋₁ (μₜ₋₁)+b (rₜ; μₜ₋₁→μₜ) can be calculated. Therefore, the calculation amount exponentially increasing with respect to the sequence length can be suppressed to a linear increase.

For example, in a case where the MLSE method is applied to the symbol determination unit 90 of the communication system 100, the symbol determination unit 90 estimates the estimated transfer function (H′) and substitutes the symbol sequence of (s′_{t-(p-1)/2}, . . . , s′ₜ, . . . , s′_{t+(p-1)/2}) indicating the transmission path state t at time t into the estimated transfer function (H′) obtained by the estimation. On the basis of the reception signal sequence {rₜ} and a sequence obtained by substituting (s′_{t-(p-1)/2}, . . . , s′ₜ, . . . , s′_{t+(p-1)/2}) into the estimated transfer function (H′), the symbol determination unit 90 calculates the metric b (rₜ; μₜ₋₁→μₜ) according to Formula (5) described above.

The symbol determination unit 90 calculates d_minₜ₋₁ (μₜ₋₁)+b (rₜ; μₜ₋₁→μₜ) indicated by Formula (6) using, for example, the Viterbi algorithm and sets the minimum value among the calculated values as d_min₁ (μₜ) that is the minimum value of the distance function dₜ ({t₁}). The symbol determination unit 90 specifies the estimated transmission symbol by tracing back the path of the trellis on the basis of the minimum value d_minₜ (μₜ) of the distance function dₜ ({μₜ}).

### CITATION LIST

### Non Patent Literature

Non Patent Literature 1: M. Ibnkahla and J. Yuan, “A neural network MLSE receiver based on natural gradient descent: application to satellite communications”, Seventh International Symposium on Signal Processing and Its Applications, 2003. Proceedings, 2003, pp. 33-36 vol. 1, doi: 10.1109/ISSPA.2003.1224633.
Non Patent Literature 2: Hiroki Taniguchi et al., “255-Gb/s PAM-8 O-band transmission using MLSE based on nonlinear channel estimation with 20-GHz bandwidth limitation”, IEICE Technical Report, OCS2019-18, (2019 June)
Non Patent Literature 3: Hiroki Taniguchi et al., “255-Gbps PAM8 O-band Transmission through 10-km SMF using simplified MLSE based on Trellis-path Limitation”, IEICE Technical Report, OCS2019-65, (2020 January)
Non Patent Literature 4: Hiroki Taniguchi et al., “225-Gbps PAM8 O-band Transmission through 20-km SMF using simplified MLSE based on Nonlinear Channel Estimation”, Proceedings of the Institute of Electronics, Information and Communication Engineers Conference (Proceedings of the Institute of Electronics, Information and Communication Engineers Society Conference), No. 2020B-10-20, (2020 Sep. 1)

### SUMMARY OF INVENTION

### Technical Problem

However, when the MLSE method is used, there is a problem that the calculation amount exponentially increases with respect to the pulse spreading width of the signal sequence in the transmission path 2. In the MLSE method, it is necessary to estimate the response characteristics of the transmission path 2, but when the direct detection method is used, there is a problem that an estimation error of the response characteristics increases due to nonlinearity of the square-law detection. In the techniques described in Non Patent Literatures 2 and 4, a method called nonlinear maximum likelihood sequence estimation (hereinafter, referred to as “Non Linear-MLSE” (NL-MLSE)) is proposed in order to solve these problems.

FIG. 31 is a block diagram illustrating a configuration of a symbol determination unit 90a of the NL-MLSE method applied instead of the symbol determination unit 90 included in the communication system 100 illustrated in FIG. 29.

The symbol determination unit 90a includes a possibility symbol sequence generation unit 91, a replica generation filter unit 92, a subtractor 93, a metric calculation unit 94, a Viterbi decoding unit 95, and an update processing unit 96. The possibility symbol sequence generation unit 91 generates a possibility symbol sequence {s′ₜ} indicating the state of the transmission path 2, that is, a symbol sequence (s′_{t-(p-1)/2}, . . . , s′ₜ, . . . , s′_{t+(p-1)/2}) of “m^{P}” transmission path states t indicated in Formula (3) described above. The replica generation filter unit 92 includes, for example, a nonlinear filter such as a Volterra filter. The replica generation filter unit 92 generates a replica of the reception signal sequence by applying a nonlinear filter to the possibility symbol sequence {s′ₜ} output from the possibility symbol sequence generation unit 91.

The subtractor 93 fetches the reception signal sequence {rₜ} and the replica of the reception signal sequence generated by the replica generation filter unit 92, subtracts the replica of the reception signal sequence from the reception signal sequence {rₜ} to obtain a subtraction value, and outputs the obtained subtraction value. The metric calculation unit 94 squares the absolute value of the subtraction value output from the subtractor 93 to calculate the metric of Formula (5) described above. The Viterbi decoding unit 95 specifies the estimated transmission symbol by applying the Viterbi algorithm to the metric calculated by the metric calculation unit 94.

The update processing unit 96 calculates an estimated transfer function (H′) on the basis of the metric calculated by the metric calculation unit 94. The update processing unit 96 calculates a tap gain value to be applied to the tap of the nonlinear filter of the replica generation filter unit 92 on the basis of the calculated estimated transfer function (H′). For example, in a case where the nonlinear filter is a Volterra filter, each of the Volterra kernels in a Volterra series is a tap. The update processing unit 96 applies the calculated tap gain value to the tap of the nonlinear filter of the replica generation filter unit 92 to update the tap gain value.

When a linear filter is applied as a filter of the replica generation filter unit 92, symbol determination is configured to be performed by the conventional MLSE method. On the other hand, in the NL-MLSE method, a nonlinear filter is applied as a filter of the replica generation filter unit 92. Therefore, in the NL-MLSE method, even when the transfer function (H) of the transmission path 2 is affected by the nonlinear response, it is possible to estimate the transfer function in consideration of the effect of the nonlinear response of the transmission path 2. Since the NL-MLSE method is a method in which noise enhancement by nonlinear calculation does not occur in principle, it can be said that it is an effective equalization method for estimating a correct transmission signal sequence {sₜ} from a reception signal waveform distorted by intersymbol interference. Accordingly, the symbol determination unit 90a adopting the NL-MLSE method compares the replica of the reception signal sequence generated using the estimated transfer function (H′) in consideration of the effect of the nonlinear response with the reception signal sequence {rₜ}, and specifies the estimated transmission symbol, thereby obtaining a most likely generation sequence, that is, the estimated transmission signal sequence formed by the specified estimated transmission symbol.

However, in a case where the nonlinear filter applied to the replica generation filter unit 92 is, for example, a tertiary Volterra filter indicated in Formula (7) described below, convolution of the nonlinear response can be performed only once. Therefore, there is a problem that the transfer function of the actual transmission path response, which is repetition of linear response and nonlinear response, cannot be approximated with high accuracy.

$$\begin{matrix}[ Math . 7 ] & \\ f ( {x}_{- 2} , {x}_{- 1} , {x}_{0} , {x}_{1} , {x}_{2} ) = {\sum }_{a = - 2}^{2} {k}_{a} {x}_{a} + {\sum }_{a = - 2}^{2} {\sum }_{b = - 2}^{2} {k}_{ab} {x}_{a} {x}_{b} + {\sum }_{a = - 2}^{2} {\sum }_{b = - 2}^{2} {\sum }_{c = - 2}^{2} {k}_{abc} {x}_{a} {x}_{b} {x}_{c} & ( 7 )\end{matrix}$$

In view of the above circumstances, an object of the present invention is to provide a technique capable of approximating a transfer function of an actual transmission path response, which is repetition of linear response and nonlinear response, with high accuracy in the NL-MLSE method.

### Solution to Problem

An aspect of the present invention is a symbol determination apparatus including: a possibility symbol sequence generation unit that generates a plurality of possibility symbol sequences that is a possibility for a transmission signal sequence formed by a transmission symbol; a transmission path estimation unit that includes a function approximator that approximates a transfer function of a transmission path that transmits the transmission signal sequence, and outputs an estimated reception symbol obtained as an output of the function approximator when each of a plurality of the possibility symbol sequences is given to the function approximator as an input sequence; a determination processing unit that specifies an estimated transmission symbol corresponding to a determination target reception symbol sequence by determining the transmission symbol by maximum likelihood sequence estimation on the basis of the determination target reception symbol sequence obtained from a reception signal sequence when the transmission path transmits the transmission signal sequence and the estimated reception symbol for each possibility symbol sequence; and an optimization unit that optimizes the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

An aspect of the present invention is a symbol determination method including: generating a plurality of possibility symbol sequences that is a possibility for a transmission signal sequence formed by a transmission symbol; outputting an estimated reception symbol obtained as an output of a function approximator that approximates a transfer function of a transmission path that transmits the transmission signal sequence when each of a plurality of the possibility symbol sequences generated is given to the function approximator as an input sequence; specifying an estimated transmission symbol corresponding to a determination target reception symbol sequence by determining the transmission symbol by maximum likelihood sequence estimation on the basis of the determination target reception symbol sequence obtained from a reception signal sequence when the transmission path transmits the transmission signal sequence and the estimated reception symbol for each possibility symbol sequence; and optimizing the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

An aspect of the present invention is a program for causing a computer to function as: a possibility symbol sequence generation means for generating a plurality of possibility symbol sequences that is a possibility for a transmission signal sequence formed by a transmission symbol; a transmission path estimation means for including a function approximator that approximates a transfer function of a transmission path that transmits the transmission signal sequence, and outputting an estimated reception symbol obtained as an output of the function approximator when each of a plurality of the possibility symbol sequences is given to the function approximator as an input sequence; a determination processing means for specifying an estimated transmission symbol corresponding to a determination target reception symbol sequence by determining the transmission symbol by maximum likelihood sequence estimation on the basis of the determination target reception symbol sequence obtained from a reception signal sequence when the transmission path transmits the transmission signal sequence and the estimated reception symbol for each possibility symbol sequence; and an optimization means for optimizing the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

### Advantageous Effects of Invention

According to this invention, it is possible to approximate a transfer function of an actual transmission path response, which is repetition of linear response and nonlinear response, with high accuracy in the NL-MLSE method.

### BRIEF DESCRIPTION OF DRAWINGS

FIG. 1 is a block diagram illustrating a configuration of a communication system according to a first embodiment.

FIG. 2 is a block diagram illustrating an internal configuration of a symbol determination unit according to the first embodiment.

FIG. 3 is a block diagram illustrating a detailed internal configuration of the symbol determination unit according to the first embodiment.

FIG. 4 is a diagram describing a sequence fetched by a phase adjustment unit according to the first embodiment.

FIG. 5 is a diagram describing an outline of pulse width compression according to the first embodiment.

FIG. 6 is a diagram illustrating an example of a configuration of a neural network according to the first embodiment.

FIG. 7 is a diagram illustrating a flow of processing by the phase adjustment unit according to the first embodiment.

FIG. 8 is a diagram illustrating a flow of processing by a maximum likelihood sequence estimation unit according to the first embodiment.

FIG. 9 is a diagram illustrating a flow of processing by an optimization unit according to the first embodiment.

FIG. 10 is a block diagram illustrating an internal configuration of a symbol determination unit according to a second embodiment.

FIG. 11 is a block diagram illustrating a detailed internal configuration of the symbol determination unit according to the second embodiment.

FIG. 12 is a diagram illustrating a flow of processing by a maximum likelihood sequence estimation unit according to the second embodiment.

FIG. 13 is a block diagram illustrating an internal configuration of a symbol determination unit according to a third embodiment.

FIG. 14 is a block diagram illustrating a detailed internal configuration of the symbol determination unit according to the third embodiment.

FIG. 15 is a diagram illustrating a flow of processing by an optimization unit of the symbol determination unit according to the third embodiment.

FIG. 16 is a block diagram illustrating a detailed internal configuration of the symbol determination unit according to the third embodiment.

FIG. 17 is a block diagram illustrating a detailed internal configuration of the symbol determination unit according to the third embodiment.

FIG. 18 is a diagram illustrating a flow of processing by the symbol determination unit according to the third embodiment.

FIG. 19 is a block diagram illustrating an internal configuration of a symbol determination unit according to a fourth embodiment.

FIG. 20 is a diagram illustrating a flow of processing by a phase adjustment unit according to the fourth embodiment.

FIG. 21 is a block diagram illustrating a configuration of a communication system used in an experiment using an experimental system.

FIG. 22 is a graph illustrating a relationship between a bit error rate measured in a communication system used in an experiment using an experimental system and the number of intermediate layers.

FIG. 23 is a graph illustrating a relationship between a bit error rate measured in a communication system used in an experiment using an experimental system and the number of nodes in an intermediate layer.

FIG. 24 is a graph illustrating an effect of band limitation of a device in a case where a transmission capacity increases.

FIG. 25 is a graph illustrating an effect of wavelength dispersion in a case where the transmission capacity increases.

FIG. 26 is a graph illustrating input/output characteristics of a driver and a light receiver.

FIG. 27 is a graph illustrating input/output characteristics of a modulator.

FIG. 28 is a graph illustrating loss characteristics in a frequency region.

FIG. 29 is a block diagram illustrating a configuration of a conventional communication system.

FIG. 30 is a block diagram of an equalization circuit of a transmission path.

FIG. 31 is a block diagram illustrating an internal configuration of a symbol determination unit corresponding to the technique disclosed in Non Patent Literature 2.

### DESCRIPTION OF EMBODIMENTS

### First Embodiment

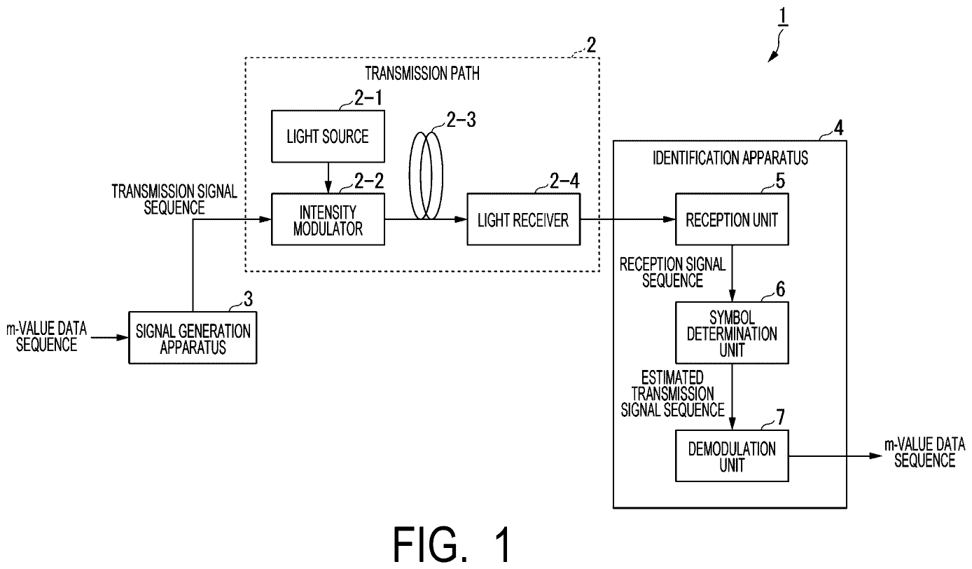

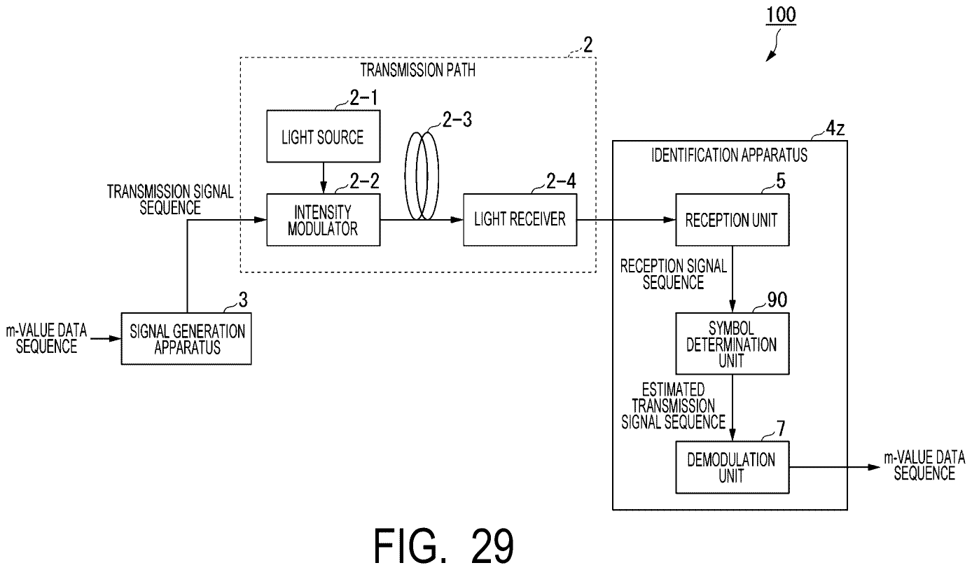

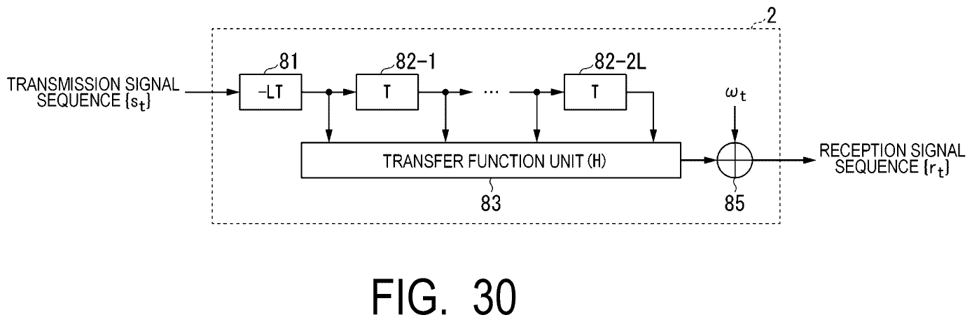

Hereinafter, embodiments of the present invention will be described with reference to the drawings. FIG. 1 is a block diagram illustrating a configuration of a communication system 1 according to a first embodiment. The communication system 1 includes a signal generation apparatus 3, a transmission path 2, and an identification apparatus 4. Note that the signal generation apparatus 3 and the transmission path 2 have the same configuration as the signal generation apparatus 3 and the transmission path 2 included in the conventional communication system 100 illustrated in FIG. 29.

The identification apparatus 4 includes a reception unit 5, a symbol determination unit 6, and a demodulation unit 7. The reception unit 5 and the demodulation unit 7 have the same configuration as the reception unit 5 and the demodulation unit 7 of the identification apparatus 4z included in the conventional communication system 100 illustrated in FIG. 29. The symbol determination unit 6 determines a transmission symbol with respect to a reception signal sequence {rₜ} of a digital electric signal output from the reception unit 5 and specifies an estimated transmission symbol corresponding to the reception signal sequence {rₜ}.

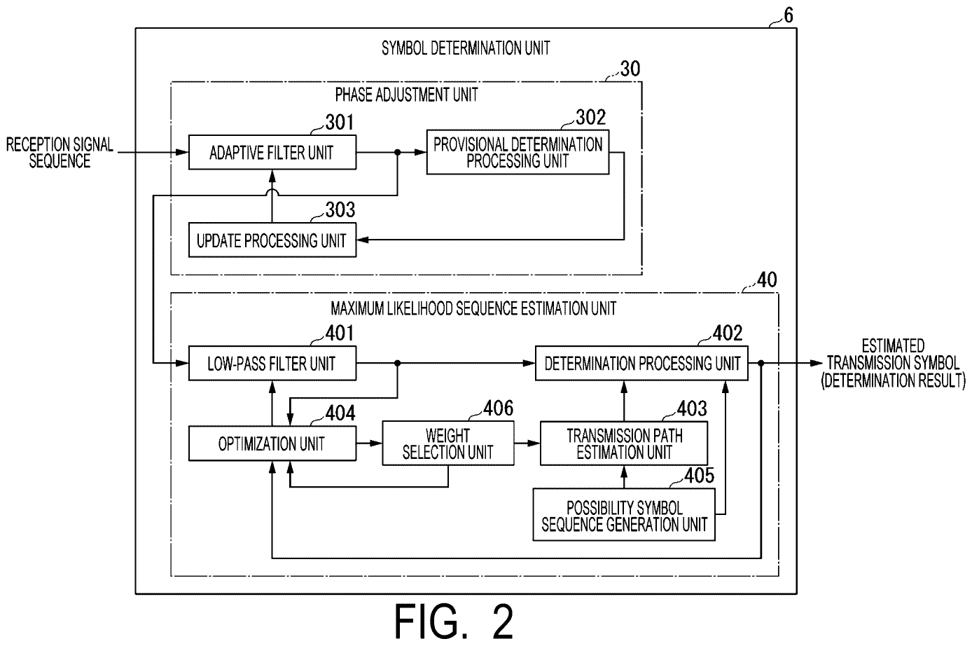

As illustrated in FIG. 2, the symbol determination unit 6 includes a phase adjustment unit 30 and a maximum likelihood sequence estimation unit 40. The phase adjustment unit 30 is, for example, a feed forward equalizer (FFE), and aligns the phase of the reception signal sequence {rₜ} of the digital electric signal with a sampling phase and outputs the reception signal sequence {rₜ}. The sampling phase is the phase of the transmission signal sequence {sₜ}.

The maximum likelihood sequence estimation unit 40 calculates a plurality of estimated reception symbols by applying an estimated transfer function (H′) to each of possibility symbol sequences {s′₁} that are transmission signal sequences {sₜ} with a limited symbol sequence length. The maximum likelihood sequence estimation unit 40 determines a transmission symbol by maximum likelihood sequence estimation on the basis of the plurality of estimated reception symbols calculated and a determination target reception symbol sequence obtained from the reception signal sequence {rₜ}. As a result, the maximum likelihood sequence estimation unit 40 specifies the estimated transmission symbol corresponding to the determination target reception symbol sequence.

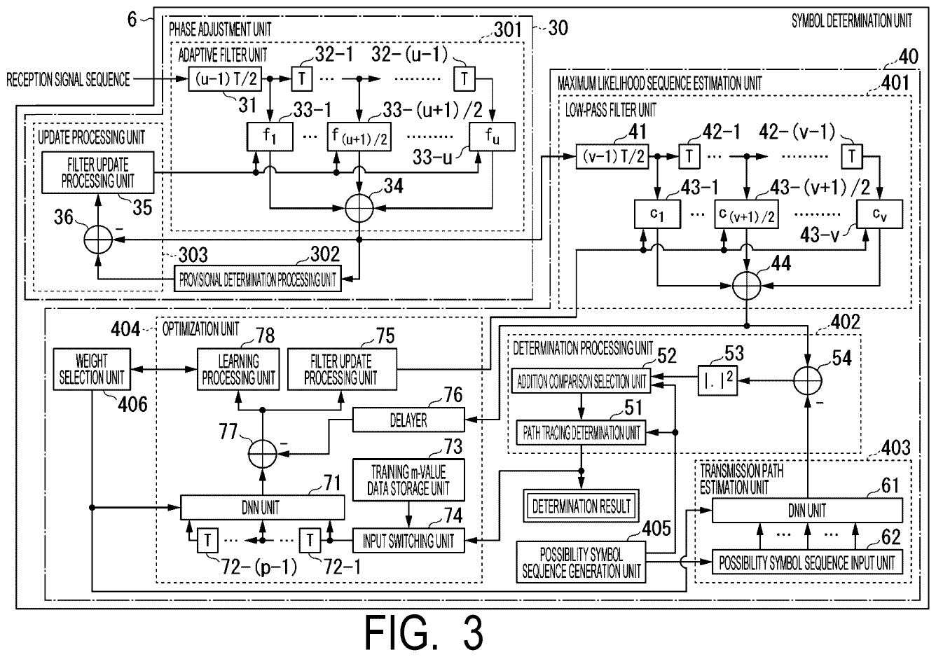

The phase adjustment unit 30 includes an adaptive filter unit 301, a provisional determination processing unit 302, and an update processing unit 303. The adaptive filter unit 301 is, for example, a linear transversal filter as illustrated in FIG. 3. The adaptive filter unit 301 performs adaptive equalization on the reception signal sequence {rₜ} that is an input signal using an estimated inverse transfer function that approximates an inverse function of a transfer function (H) of the transmission path 2.

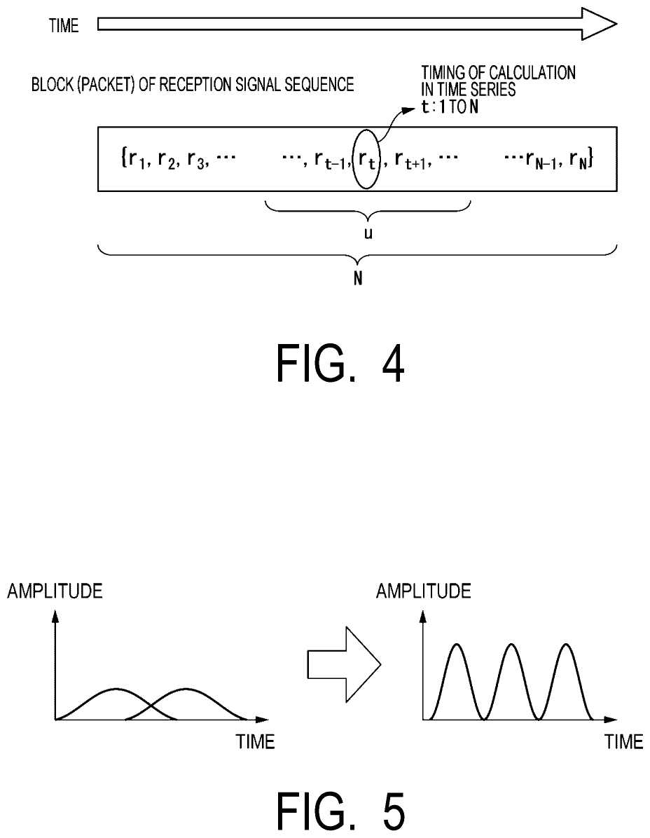

As illustrated in FIG. 3, the adaptive filter unit 301 includes delayers 31 and 32-1 to 32-(u−1), taps 33-1 to 33-u, and an adder 34. As illustrated in FIG. 4, the delayer 31 fetches u symbol sequences centered on the symbol at time t that is a part of the reception signal sequence {rₜ} having the sequence length N. The delayer 31 outputs a symbol r_{t-(u-1)/2} before time t by “(u−1)T/2”, that is, “(u−1)/2” symbols before the symbol at time t from the fetched u symbol sequences. Therefore, r_{t-(u-1)/2} output from the delayer 31 is given to the tap 33-1.

Each of the delayers 32-1 and 32-2 to 32-(u−1) outputs a symbol one symbol after the symbol output from a previous delayer 31 or 32-1 to 32-(u−2) connected thereto. For example, the first delayer 32-1 outputs, from the u symbol sequences, a symbol r_{t-(u-3)/2} that is “(u−3)T/2” time before time t, that is, “(u−3)/2” symbols before the symbol at time t. The last delayer 32-(u−1) outputs, from the u symbol sequences, a symbol r_{t+(u-1)/2} that is “(u−1)T/2” time after time t, that is, “(u−1)/2” symbols after the symbol at time t. As a result, a signal including a symbol sequence having a sequence length u indicated by Formula (8) described below is given to the taps 33-1 to 33-u.

$$\begin{matrix}[ Math . 8 ] & \\ {r}_{t - ( u - 1 ) / 2} , … , {r}_{t} , … , {r}_{t + ( u - 1 ) / 2} & ( 8 )\end{matrix}$$

Tap gain values of f₁, f₂, . . . , f_{(u+1)/2}, . . . , and fᵤ, which are so-called filter coefficients, are set for each of the taps 33-1 to 33-u. The tap gain values f₁ to fᵤ indicate an estimated inverse transfer function that approximates an inverse function of the transfer function (H) of the transmission path 2. Each of the taps 33-1 to 33-u multiplies a symbol given to each of the taps by each of the tap gain values f₁ to fᵤ and outputs the symbol. The adder 34 sums and outputs the output values of the taps 33-1 to 33-u. The sequence of the signal indicated by Formula (8) can be said to be a sequence centered on rₜ at time t that is a “(u+1)/2”-th element. Therefore, the output value of the adder 34 is a value obtained by calculation indicated by Formula (9) described below.

$$\begin{matrix}[ Math . 9 ] & \\ {out}_{filter \_ u} = {\sum }_{j = 1}^{u} {f}_{j} {r}_{t - \frac{u + 1}{2} + j} & ( 9 )\end{matrix}$$

The provisional determination processing unit 302 performs the provisional determination of the transmission symbol by a hard decision on the output value of the adaptive filter unit 301. The provisional determination processing unit 302 outputs the provisionally determined transmission symbol (hereinafter, referred to as a “provisionally determined symbol”) as a provisional determination result.

The update processing unit 303 calculates update values of the tap gain values f₁ to fᵤ of the taps 33-1 to 33-u of the adaptive filter unit 301 as the provisionally determined symbol output from the provisional determination processing unit 302 as the target value of the output value of the adaptive filter unit 301. For example, the update processing unit 303 calculates update values of the tap gain values f₁ to fᵤ indicating the estimated inverse transfer function using a least mean square (LMS) algorithm.

As illustrated in FIG. 3, the update processing unit 303 includes a filter update processing unit 35 and a subtractor 36. In the update processing unit 303, the subtractor 36 outputs, as an error, a subtraction value obtained by subtracting the output value of the adaptive filter unit 301 from the provisionally determined symbol output from the provisional determination processing unit 302 to the filter update processing unit 35.

The filter update processing unit 35 calculates the update values of the tap gain values f₁ to fᵤ by the LMS algorithm so as to reduce the error output from the subtractor 36. The filter update processing unit 35 sets the calculated update values of the tap gain values f₁ to fᵤ to the taps 33-1 to 33-u and updates the tap gain values f₁ to fᵤ.

The maximum likelihood sequence estimation unit 40 includes a low-pass filter unit 401, a determination processing unit 402, a transmission path estimation unit 403, an optimization unit 404, a possibility symbol sequence generation unit 405, and a weight selection unit 406. The low-pass filter unit 401 is, for example, a linear transversal filter as illustrated in FIG. 3, and is a low-pass filter that suppresses a high-frequency component. Since the adaptive filter unit 301 of the phase adjustment unit 30 amplifies the high-frequency component decreased by the transmission path 2, the high-frequency component of white noise is also amplified. The low-pass filter unit 401 suppresses the high-frequency component of the white noise amplified by the adaptive filter unit 301 in the preceding stage. The low-pass filter unit 401 compresses the impulse response of the reception signal sequence {rₜ} in order to reduce the storage length of the transmission path estimation unit 403. Here, as illustrated in FIG. 5, the compression of the impulse response is to compress a pulse width of a signal sequence that is temporally widened due to band limitation or wavelength dispersion, and interference between symbols can be reduced by the compression.

As illustrated in FIG. 3, the low-pass filter unit 401 includes delayers 41 and 42-1 to 42-(v−1), taps 43-1 to 43-v, and an adder 44. Similarly to the delayer 31, the delayer 41 fetches v symbol sequences centered on the symbol at time t that is a part of an output signal sequence of the adaptive filter unit 301 of the phase adjustment unit 30 by the method illustrated in FIG. 4. Hereinafter, the output signal sequence of the adaptive filter unit 301 is indicated as {r′ₜ}.

The delayer 41 outputs a symbol r′_{t-(v-1)/2} before time t by “(v−1)T/2”, that is, “(v−1)/2” symbols before the symbol at time t from the fetched v symbol sequences. Therefore, r′_{t-(v-1)/2} output from the delayer 41 is given to the tap 43-1.

Each of the delayers 42-1 and 42-1 to 42-(v−1) outputs a symbol one symbol after the symbol output from a previous delayer 41 or 42-1 to 42-(v−2) connected thereto. For example, the first delayer 42-1 outputs, from the v symbol sequences, a symbol r′_{t-(v-3)/2} that is “(v−3)T/2” time before time t, that is, “(v−3)/2” symbols before the symbol at time t. The last delayer 42-(v−1) outputs, from the v symbol sequences, a symbol r′_{t+(v-1)/2} that is “(v−1)T/2” time after time t, that is, “(v−1)/2” symbols after the symbol at time t. As a result, a signal including a symbol sequence having a sequence length v indicated by Formula (10) described below is given to the taps 43-1 to 43-v.

$$\begin{matrix}[ Math . 10 ] & \\ {{r}^{′}}_{t - ( v - 1 ) / 2} , … , {{r}^{′}}_{t} , … , {{r}^{′}}_{t + ( v - 1 ) / 2} & ( 10 )\end{matrix}$$

Tap gain values of c₁, c₂, . . . , c_{(v+1)/2}, . . . , and cᵥ, which are so-called filter coefficients, are set for each of the taps 43-1 to 43-v. Each of the taps 43-1 to 43-v multiplies a symbol given to each of the taps by each of the tap gain values and outputs the symbol. The adder 44 sums and outputs the output values of the taps 43-1 to 43-v. Since Formula (10) can be said to be a sequence centered on r′ₜ at time t that is a “(v+1)/2”-th element, the output value of the adder 44 is a value obtained by calculation indicated by Formula (11) described below.

$$\begin{matrix}[ Math . 11 ] & \\ {out}_{filter \_ v} = {\sum }_{j = 1}^{v} {c}_{j} {{r}^{′}}_{t - \frac{v + 1}{2} + j} & ( 11 )\end{matrix}$$

As can be seen from Formula (11), the degree of effect is adjusted by the tap gain values c₁, c₂, . . . , c_{(v+1)/2}, . . . , and cᵥ, but the low-pass filter unit 401 outputs one output symbol obtained by compressing the amount of information of the v symbol sequences. Although it is known that the calculation amount of the MLSE exponentially increases with respect to the spreading width of the pulse, an increase in calculation amount can be suppressed by compressing the pulse width by the low-pass filter unit 401. The output value output from the adder 44 of the low-pass filter unit 401 becomes a determination target reception symbol, and a determination target reception symbol sequence is formed by arranging the determination target reception symbols in time series.

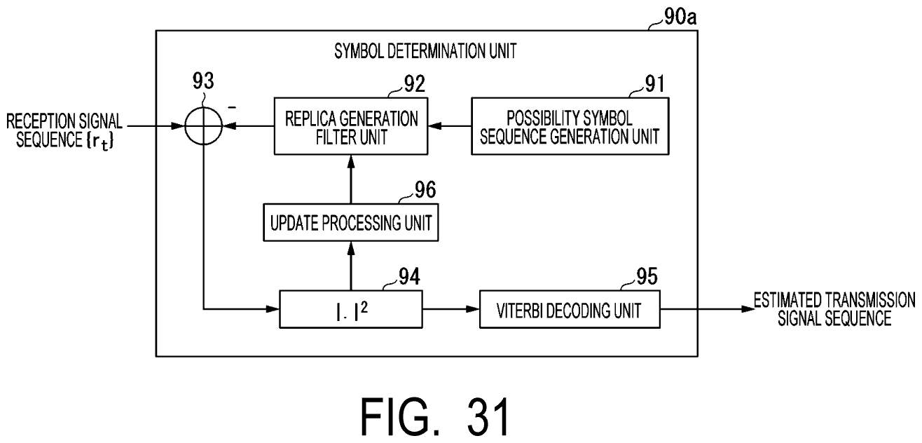

The possibility symbol sequence generation unit 405 has the same configuration as the possibility symbol sequence generation unit 91 illustrated in FIG. 31, and generates a possibility symbol sequence {s′ₜ} that is a transmission signal sequence {sₜ} with a limited symbol sequence length. The possibility symbol sequence {s′ₜ} is a symbol sequence (s′_{t-(p-1)/2}, . . . , s′ₜ, . . . , s′_{t+(p-1)/2}) of “m^{p}” transmission path states μₜ indicated in Formula (3) described above. For example, it is assumed that PAM4 is employed and m=4, and each symbol is indicated by a number [0, 1, 2, 3]. Assuming that the sequence length p=3, the possibility symbol sequence generation unit 405 generates 4³, that is, 64 possibility symbol sequences {s′ₜ} of [0,0,0], [0,0,1], to, [2,2,3], [2,3,0], to, [3,3,3]. The possibility symbol sequence generation unit 405 outputs the generated “m^{P}” possibility symbol sequences {s′ₜ} for each sequence to an addition comparison selection unit 52, a path tracing determination unit 51, and the transmission path estimation unit 403.

The transmission path estimation unit 403 includes a function approximator that approximates the transfer function (H) of the transmission path 2, that is, a deep neural network that is a function approximator that calculates the estimated transfer function (H′). The transmission path estimation unit 403 gives each of the plurality of possibility symbol sequences {s′ₜ} generated by the possibility symbol sequence generation unit 405 to the deep neural network as an input sequence, thereby calculating an estimated reception symbol corresponding to each of the input sequences. An estimated reception symbol sequence is formed by arranging the plurality of estimated reception symbols calculated by the transmission path estimation unit 403 in time series.

As illustrated in FIG. 3, the transmission path estimation unit 403 includes a deep neural network (DNN) unit 61 and a possibility symbol sequence input unit 62. The possibility symbol sequence input unit 62 sequentially fetches “me” possibility symbol sequences {s′ₜ} output for each sequence by the possibility symbol sequence generation unit 405, and outputs each of the plurality of possibility symbols included in the possibility symbol sequences {s′ₜ} to the corresponding node of the input layer of the DNN unit 61 in order of fetching. Note that, in a case where the possibility symbol sequence generation unit 405 is configured to output the symbols included in the possibility symbol sequences {s′ₜ} one symbol at a time for each time T, the possibility symbol sequence input unit 62 may be configured to couple p−1 delayers that output the fetched symbols after delay of time T, similarly to delayers 72-1 to 72-(p−1) of the optimization unit 404 described below.

The DNN unit 61 is, for example, a feed-forward deep neural network, and repeatedly calculates a recurrence formula of Formula (12) described below.

$$\begin{matrix}[ Math . 12 ] & \\ {X}_{i + 1} = f ( {W}_{i} {X}_{i} + {B}_{i} ) & ( 12 )\end{matrix}$$

In Formula (12) described above, Xᵢ₊₁ is an output vector of an i layer, Xᵢ is an input vector of the i layer, Wᵢ is a weight parameter matrix, and Bi is a bias parameter matrix. The function f(⋅) is an activation function, and for example, a rectified linear unit (ReLU) function indicated by Formula (13) described below is applied.

$$\begin{matrix}[ Math . 13 ] & \\ f ( x ) = max ( 0 , x ) & ( 13 )\end{matrix}$$

The function f(⋅) is a function that performs nonlinear calculation. Therefore, the repetition calculation of the recurrence formula of Formula (12) described below is repetition calculation of linear convolution and nonlinear calculation. Accordingly, by applying an appropriate weight parameter and an appropriate bias parameter, the transfer function (H) indicating the transmission response of the transmission path 2, which is repetition of the linear response and the nonlinear response, can be approximated by the DNN unit 61.

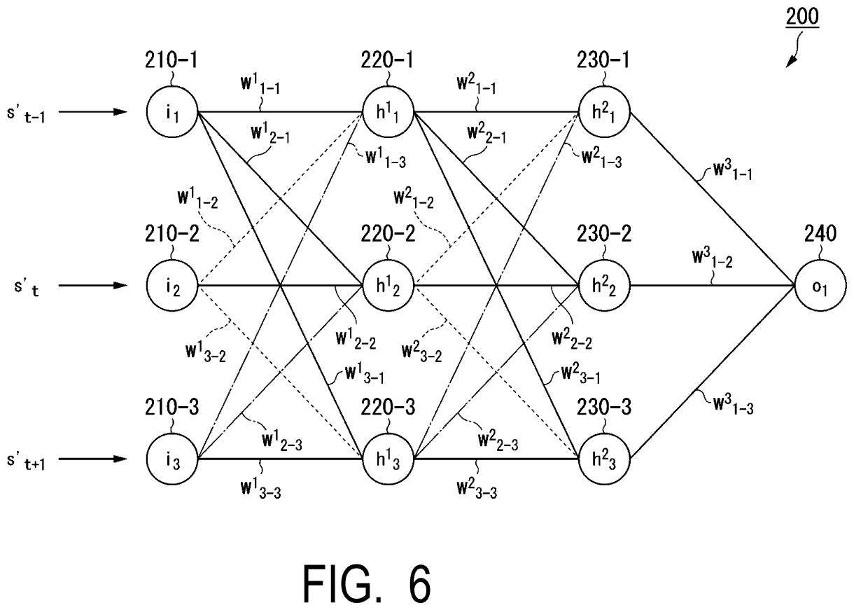

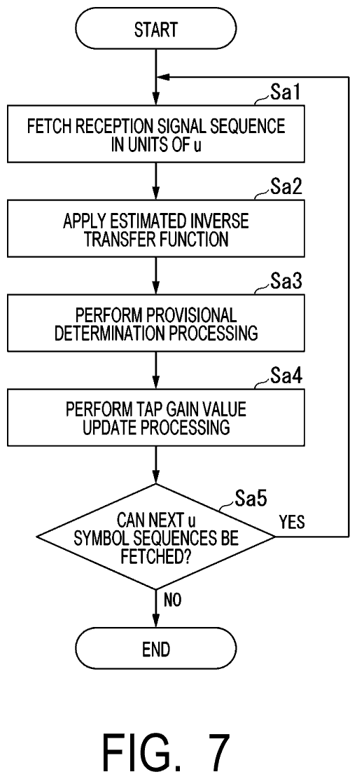

For example, it is assumed that the sequence length p of the possibility symbol sequence {s′ₜ} generated by the possibility symbol sequence generation unit 405 is “3”. In this case, the DNN unit 61 includes, for example, a neural network 200 that is a feed-forward deep neural network as illustrated in FIG. 6 and is a so-called multilayer perceptron. The neural network 200 includes input layer nodes 210-1, 210-2, and 210-3, first intermediate layer nodes 220-1, 220-2, and 220-3, second intermediate layer nodes 230-1, 230-2, and 230-3, and an output layer node 240. Hereinafter, each of the input layer nodes 210-1 to 210-3, the first intermediate layer nodes 220-1 to 220-3, the second intermediate layer nodes 230-1 to 230-3, and the output layer node 240 is also referred to as a neuron. The connection between two neurons is also referred to as a synapse.

Each of the input layer nodes 210-1, 210-2, and 210-3 fetches each symbol of possibility symbol sequences {s′ₜ₋₁, s′ₜ, s′ₜ₊₁} of a sequence length 3. For example, the input layer node 210-1 fetches s′ₜ₋₁ and outputs the fetched s′ₜ₋₁ as output value i₁. The input layer node 210-2 fetches s′ₜ and outputs the fetched s′ₜ as output value i₂. The input layer node 210-3 fetches s′ₜ₊₁ and outputs the fetched s′ₜ₊₁ as output value i₃.

Here, as indicated in Formula (14) described below, a vertical vector having output values i₁, i₂, and i₃ of the input layer nodes 210-1, 210-2, and 210-3 as elements is defined as vector i.

$$\begin{matrix}[ Math . 14 ] & \\ i = ( \begin{matrix}{i}_{1} \\ {i}_{2} \\ {i}_{3}\end{matrix} ) & ( 14 )\end{matrix}$$

Each of the input layer nodes 210-1, 210-2, and 210-3 and each of the first intermediate layer nodes 220-1, 220-2, and 220-3 are interconnected. The first intermediate layer node 220-1 multiplies the output value i₁ output from the input layer node 210-1 by a weight w¹ᵢ₋₁, multiplies the output value i₂ output from the input layer node 210-2 by a weight w¹ᵢ₋₂, multiplies the output value i₃ output from the input layer node 210-3 by a weight w¹ᵢ₋₃, and applies the activation function f(⋅) to the sum of the multiplication values obtained by the three multiplications. The first intermediate layer node 220-1 calculates an output value h¹₁ by adding a bias b¹₁ to the output value of the activation function f(⋅). Here, as indicated in Formula (15) described below, a horizontal vector having the weights w¹₁₋₁, w¹₂₋₁, and w¹₃₋₁ multiplied by the first intermediate layer node 220-1 as elements is defined as vector W¹₁.

$$\begin{matrix}[ Math . 15 ] & \\ {W}_{1}^{1} = ( \begin{matrix}\begin{matrix}{w}_{1 - 1}^{1} & {w}_{1 - 2}^{1}\end{matrix} & {w}_{1 - 3}^{1}\end{matrix} ) & ( 15 )\end{matrix}$$

In this case, the output value h¹₁ of the first intermediate layer node 220-1 can be indicated as Formula (16) described below using Formulae (12), (14), and (15).

$$\begin{matrix}[ Math . 16 ] & \\ {h}_{1}^{1} = f ( {W}_{1}^{1} \cdot i ) + {b}_{1}^{1} & ( 16 )\end{matrix}$$

Similarly, the output value h¹₂ of the first intermediate layer node 220-2 can be indicated by Formula (17) described below.

$$\begin{matrix}[ Math . 17 ] & \\ \begin{matrix}{h}_{2}^{1} = f ( {W}_{2}^{1} \cdot i ) + {b}_{2}^{1} \\ {W}_{2}^{1} = ( \begin{matrix}\begin{matrix}{w}_{2 - 1}^{1} & {w}_{2 - 2}^{1}\end{matrix} & {w}_{2 - 3}^{1}\end{matrix} )\end{matrix} \} & ( 17 )\end{matrix}$$

Similarly, the output value h¹₃ of the first intermediate layer node 220-3 can be indicated by Formula (18) described below.

$$\begin{matrix}[ Math . 18 ] & \\ \begin{matrix}{h}_{3}^{1} = f ( {W}_{3}^{1} \cdot i ) + {b}_{3}^{1} \\ {W}_{3}^{1} = ( \begin{matrix}\begin{matrix}{w}_{3 - 1}^{1} & {w}_{3 - 2}^{1}\end{matrix} & {w}_{3 - 3}^{1}\end{matrix} )\end{matrix} \} & ( 18 )\end{matrix}$$

In Formulae (16) to (18) described above, b¹₁, b¹₂, and b¹₃ are biases added by each of the first intermediate layer nodes 220-1, 220-2, and 220-3. Each of the first intermediate layer nodes 220-1, 220-2, and 220-3 and each of the second intermediate layer nodes 230-1, 230-2, and 230-3 are interconnected. Here, as indicated in Formula (19) described below, a vertical vector having output values h¹₁, h¹₂, and h¹₂ of the respective first intermediate layer nodes 220-1, 220-2, and 220-3 as elements is defined as vector h¹.

$$\begin{matrix}[ Math . 19 ] & \\ {h}^{1} = ( \begin{matrix}{h}_{1}^{1} \\ {h}_{2}^{1} \\ {h}_{3}^{1}\end{matrix} ) & ( 19 )\end{matrix}$$

In this case, output values h²₁, h²₂, and h²₃ of the respective second intermediate layer nodes 230-1, 230-2, and 230-3 can be indicated by Formula (20) described below using the vector h¹. Note that, in Formula (20) described below, b²₁, b²₂, and b³₃ are biases added by each of the second intermediate layer nodes 230-1, 230-2, and 230-3. In Formula (20) described below, vectors W²₁, W²₂, and W²₃ are defined by Formula (21) described below.

$$\begin{matrix}[ Math . 20 ] & \\ \begin{matrix}{h}_{1}^{2} = f ( {W}_{1}^{2} \cdot {h}^{1} ) + {b}_{1}^{2} \\ {h}_{2}^{2} = f ( {W}_{2}^{2} \cdot {h}^{1} ) + {b}_{2}^{2} \\ {h}_{3}^{2} = f ( {W}_{3}^{2} \cdot {h}^{1} ) + {b}_{3}^{2}\end{matrix} \} & ( 20 )\end{matrix}$$

$$\begin{matrix}[ Math . 21 ] & \\ \begin{matrix}{W}_{1}^{2} = ( \begin{matrix}\begin{matrix}{w}_{1 - 1}^{2} & {w}_{1 - 2}^{2}\end{matrix} & {w}_{1 - 3}^{2}\end{matrix} ) \\ {W}_{2}^{2} = ( \begin{matrix}\begin{matrix}{w}_{2 - 1}^{2} & {w}_{2 - 2}^{2}\end{matrix} & {w}_{2 - 3}^{2}\end{matrix} ) \\ {W}_{3}^{2} = ( \begin{matrix}\begin{matrix}{w}_{3 - 1}^{2} & {w}_{3 - 2}^{2}\end{matrix} & {w}_{3 - 3}^{2}\end{matrix} )\end{matrix} \} & ( 21 )\end{matrix}$$

Each of the second intermediate layer nodes 230-1, 230-2, and 230-3 connects to the output layer node 240. Here, as indicated in Formula (22) described below, a vertical vector having output values h²₁, h²₂, and h²₃ of the second intermediate layer nodes 230-1, 230-2, and 230-3 as elements is defined as vector h².

$$\begin{matrix}[ Math . 22 ] & \\ {h}^{2} = ( \begin{matrix}{h}_{1}^{2} \\ {h}_{2}^{2} \\ {h}_{3}^{2}\end{matrix} ) & ( 22 )\end{matrix}$$

In this case, an output value o₁ of the output layer node 240 can be indicated by Formula (23) described below using the vector h². Note that, in Formula (23) described below, b³₁ is a bias added by the output layer node 240.

$$\begin{matrix}[ Math . 23 ] & \\ \begin{matrix}{o}_{1} = f ( {W}_{1}^{3} \cdot {h}^{2} ) + {b}_{2}^{3} \\ {W}_{1}^{3} = ( \begin{matrix}\begin{matrix}{w}_{1 - 1}^{3} & {w}_{1 - 2}^{3}\end{matrix} & {w}_{1 - 3}^{3}\end{matrix} )\end{matrix} \} & ( 23 )\end{matrix}$$

A weight and a bias indicating the estimated transfer function (H′) can be obtained by supervised learning processing performed in advance using a combination of a plurality of input sequences and a correct answer label of an output corresponding to each of the plurality of input sequences. The weights and the biases obtained by the supervised learning processing are set for the corresponding first intermediate layer nodes 220-1 to 220-3, second intermediate layer nodes 230-1 to 230-3, and output layer node 240. As a result, when the possibility symbol sequence {s′ₜ} is given to the input layer nodes 210-1 to 210-3, an estimated reception symbol is obtained as the output value o₁ of the output layer node 240. Note that, in the following description, a combination of a weight and a bias applied to a certain neuron is also referred to as a coefficient.

When the sequence length of the possibility symbol sequence {s′ₜ} is p, the neural network 200 includes p input layer nodes, input layer nodes 210-1, 210-2, . . . , and 210-p. The configuration of the neural network 200 illustrated in FIG. 6 is an example of the deep neural network included in the DNN unit 61. There is a structural limitation that the number of nodes in the input layer is matched with the number of sequence lengths p of the possibility symbol sequence {s′ₜ} generated by the possibility symbol sequence generation unit 405 and the number of nodes in the output layer is one, but the number of intermediate layers is not limited to two, but may be three or more. The number of nodes in the intermediate layer is not limited to six illustrated in FIG. 6, but may be any number. The number of intermediate layers and the number of nodes in the intermediate layer are appropriately set to have approximate numbers in advance depending on the complexity of an approximate function, the number of input sequences used for the learning processing, and the like.

Returning to FIG. 2, the determination processing unit 402 calculates the metric on the basis of the determination target reception symbol sequence output by the low-pass filter unit 401 and the plurality of estimated reception symbols calculated by the transmission path estimation unit 403. The determination processing unit 402 determines a transmission symbol by maximum likelihood sequence estimation on the basis of the calculated metric to specify an estimated transmission symbol corresponding to the determination target reception symbol sequence.

As illustrated in FIG. 3, the determination processing unit 402 includes a subtractor 54, a metric calculation unit 53, the addition comparison selection unit 52, and the path tracing determination unit 51. The subtractor 54 calculates a subtraction value obtained by subtracting each of a plurality of estimated reception symbols H′ (S′ₜ) output by the transmission path estimation unit 403 from the determination target reception symbol that is the output value of the low-pass filter unit 401 indicated by Formula (11). Here, “S′ₜ” corresponds to a symbol sequence defined by Formula (24) described below, that is, each of a plurality of possibility symbol sequences {s′ₜ} to be an input sequence of the DNN unit 61.

$$\begin{matrix}[ Math . 24 ] & \\ {S}_{t}^{′} = {s}_{t - ( p - 1 ) / 2}^{′} , … , {s}_{t}^{′} , … , {s}_{t + ( p - 1 ) / 2}^{′} & ( 24 )\end{matrix}$$

The number of subtraction values calculated by the subtractor 54 matches the number of possibility symbol sequences {s′ₜ} generated by the possibility symbol sequence generation unit 405, and thus is m^{p}. The metric calculation unit 53 calculates a plurality of metrics by the calculation indicated by Formula (25) described below, i.e., squaring an absolute value of each of a plurality of subtraction values output from the subtractor 54.

$$\begin{matrix}[ Math . 25 ] & \\ b ( {r}_{t} ; {μ}_{t - 1} \to {μ}_{t} ) = {\vert {{\sum }_{j = 1}}^{v} {c}_{j} {r}_{t - \frac{v + 1}{2} + j}^{′} - {H}^{′} ( {S}_{t}^{′} ) \vert}^{2} & ( 25 )\end{matrix}$$

The addition comparison selection unit 52 performs the method described with reference to Formulae (4) to (6) described above by, for example, the Viterbi algorithm. That is, the addition comparison selection unit 52 calculates a distance function dₜ ({μₜ}) corresponding to each of the plurality of metrics on the basis of the possibility symbol sequence {s′ₜ} output from the possibility symbol sequence generation unit 405 and the plurality of metrics output from the metric calculation unit 53. The addition comparison selection unit 52 detects a minimum value d_minₜ ({μₜ}) of the calculated distance function dₜ ({μₜ}).

The path tracing determination unit 51 generates a path of the trellis on the basis of the possibility symbol sequence {s′ₜ} output by the possibility symbol sequence generation unit 405 and the minimum value d_minₜ ({μₜ}) of the distance function dₜ ({kt}) detected by the addition comparison selection unit 52. The path tracing determination unit 51 traces the generated path of the trellis and specifies the estimated transmission symbol corresponding to the determination target reception symbol sequence. The number of times of tracing back “w” when the path tracing determination unit 51 traces back the path is determined in advance, and by setting the number of times of tracing back “w” to a fixed value, it is possible to reduce the calculation amount required to determine the path to be traced back. Note that it is known that the path converges by tracing back about several times the input sequence length p of the DNN unit 61 included in the transmission path estimation unit 403.

Hereinafter, the estimated transmission symbol corresponding to time t specified by the path tracing determination unit 51 by tracing back the path of the trellis is referred to as an estimated transmission symbol aₜ. The path tracing determination unit 51 outputs the estimated transmission symbol aₜ as a determination result. As indicated by Formula (26) described below, a sequence in which p estimated transmission symbols at are arranged in time series is an estimated transmission signal sequence Aₜ.

$$\begin{matrix}[ Math . 26 ] & \\ {A}_{t} = {a}_{t - ( p - 1 ) / 2} , … , {a}_{t} , … , {a}_{t + ( p - 1 ) / 2} & ( 26 )\end{matrix}$$

The optimization unit 404 optimizes tap gain values c₁ to cᵥ to be applied to the taps 43-1 to 43-v of the low-pass filter unit 401 and optimizes coefficients to be applied to the DNN units 61 and 71, on the basis of a transmission signal sequence generated from a training in-value data sequence prepared in advance or the estimated transmission signal sequence Aₜ and a determination target reception symbol that is an output value of the low-pass filter unit 401.

The optimization unit 404 includes the DNN unit 71, delayers 72-1 to 72-(p−1), a training m-value data storage unit 73, an input switching unit 74, a filter update processing unit 75, a delayer 76, a subtractor 77, and a learning processing unit 78. The DNN unit 71 has the same configuration as the DNN unit 61 of the transmission path estimation unit 403. The delayer 72-1 delays a symbol output from the input switching unit 74 by one symbol and outputs the delayed symbol. The delayers 72-2 to 72-(p−1) output a symbol one symbol after the symbol output from a previous delayer 72-1 to 72-(p−2) connected thereto. Here, p is the sequence length of the possibility symbol sequence {s′ₜ} generated by the possibility symbol sequence generation unit 405 as described above, and matches the number of nodes in the input layer of the DNN units 61 and 71.

The training m-value data storage unit 73 stores a plurality of pieces of predetermined training m-value data used when the supervised learning is performed in the DNN unit 71 in a predetermined order. Here, the predetermined order matches the order in which a plurality of pieces of training m-value data is given to the signal generation apparatus 3.

That is, the signal generation apparatus 3 is provided with the training m-value data sequence formed by the plurality of pieces of training m-value data arranged in the order, so that the signal generation apparatus 3 generates the transmission signal sequence {sₜ} corresponding to the training m-value data sequence and sends the transmission signal sequence {sₜ} to the transmission path 2. The transmission signal sequence {s_{L}} sent by the signal generation apparatus 3 is transmitted to the identification apparatus 4 through the transmission path 2. The reception unit 5 of the identification apparatus 4 receives the reception signal sequence {rₜ}, performs preprocessing, and outputs the reception signal sequence {rₜ} of the digital electric signal to the symbol determination unit 6. As a result, the optimization unit 404 of the symbol determination unit 6 acquires the determination target reception symbol sequence corresponding to the training m-value data sequence. The determination target reception symbol included in the acquired determination target reception symbol sequence is sequentially set as the correct answer label of the output of the DNN unit 71 from the head. On the other hand, each sequence of consecutive transmission symbols extracted while shifting the transmission symbols included in the transmission signal sequence generated from the training m-value data sequence stored in the training m-value data storage unit 73 backward by one symbol in order from the head so that the sequence length becomes p is given to the DNN unit 71 as an input sequence. As a result, it is possible to perform supervised learning processing for constructing the neural network 200 that calculates the estimated transfer function (H′).

The input switching unit 74 is provided with a region for storing information indicating a mode in the internal storage region, and information indicating a training mode or information indicating an operation mode is written as the information indicating the mode. When the information indicating the mode indicates the training mode, the input switching unit 74 sequentially outputs the transmission symbols included in the transmission signal sequence generated in advance from the training m-value data sequence stored in the training m-value data storage unit 73 from the head. When the information indicating the mode indicates the operation mode, the input switching unit 74 fetches the estimated transmission symbol output by the path tracing determination unit 51 and outputs the estimated transmission symbol to the delayer 72-1.

The delayer 76 fetches the output value output from the low-pass filter unit 401, that is, the determination target reception symbol, and outputs the fetched determination target reception symbol after a time of “wT+(p−1)T/2”, that is, a time of “w+(p−1)/2” symbol has elapsed to the subtractor 77. In order to use the determination target reception symbol output by the low-pass filter unit 401 as the correct answer label of the supervised learning of the DNN unit 71, the determination target reception symbol needs to be a determination target reception symbol to be processed by the metric calculation unit 53, the addition comparison selection unit 52, and the path tracing determination unit 51 when the estimated transmission symbol aₜ is obtained.

Here, the time at which a certain determination target reception symbol is obtained is assumed to be time t on the time axis of the reception signal sequence {rₜ}. Since time wT elapses due to the processing performed by the path tracing determination unit 51, the estimated transmission symbol aₜ corresponding to the determination target reception symbol is output from the path tracing determination unit 51 at the time point of time t+wT on the time axis of the reception signal sequence {rₜ}. In other words, the time at which the determination target reception symbol corresponding to the estimated transmission symbol aₜ is obtained is time t on the time axis of the reception signal sequence {rₜ}, but is time t−wT on the time axis of the estimated transmission symbol aₜ. Furthermore, it takes time of (p−1)T/2 for the estimated transmission symbol aₜ to become the center position of the input sequence having the sequence length p given to the DNN unit 71. Accordingly, when indicated by the time axis of the estimated transmission symbol aₜ, the delayer 76 outputs the determination target reception symbol output by the low-pass filter unit 401 at time t−wT−(p−1)T/2 to the subtractor 77 after a time of “wT+(p−1)T/2” has elapsed at the time point of time t.

The subtractor 77 subtracts the output value of the delayer 76 from the output value of the DNN unit 71, and outputs an error obtained by the subtraction to the filter update processing unit 75 and the learning processing unit 78.

The filter update processing unit 75 calculates the update values of the tap gain values ci to cᵥ, for example, by the LMS algorithm so as to reduce the error on the basis of the error output from the subtractor 77. The filter update processing unit 75 sets the calculated update values of the tap gain values c₁ to cᵥ to the taps 43-1 to 43-v and updates the tap gain values c₁ to cᵥ.

The learning processing unit 78 calculates new coefficients, that is, weights and biases, to be applied to the DNN unit 71 and the DNN unit 61, for example, by the error backpropagation method so as to minimize the error output from the subtractor 77. The learning processing unit 78 outputs the calculated new coefficients to the weight selection unit 406.

In a case where a weight selection flag indicating whether or not to perform the weight selection processing stored in the internal storage region indicates that the weight selection processing is to be performed, the weight selection unit 406 performs processing of selecting a weight to be applied to the DNN units 61 and 71 described below. That is, the weight selection unit 406 reduces connections between neurons of the neural network 200 having a small weight value, that is, synapses between the neurons, on the basis of the absolute value of the weight included in the coefficient output by the learning processing unit 78 and a predetermined weight threshold. For example, the weight selection unit 406 rewrites the weight whose absolute value is equal to or less than the weight threshold to “0”, and then sets a new coefficient for the DNN unit 71 and the DNN unit 61 to update the coefficient. As a result, at the neurons connected to both ends of the synapse whose weight is set to “0”, the output value of the neurons in the preceding stage does not propagate to neurons in the subsequent stage, and the synapse between the two neurons is lost.

### Processing of First Embodiment

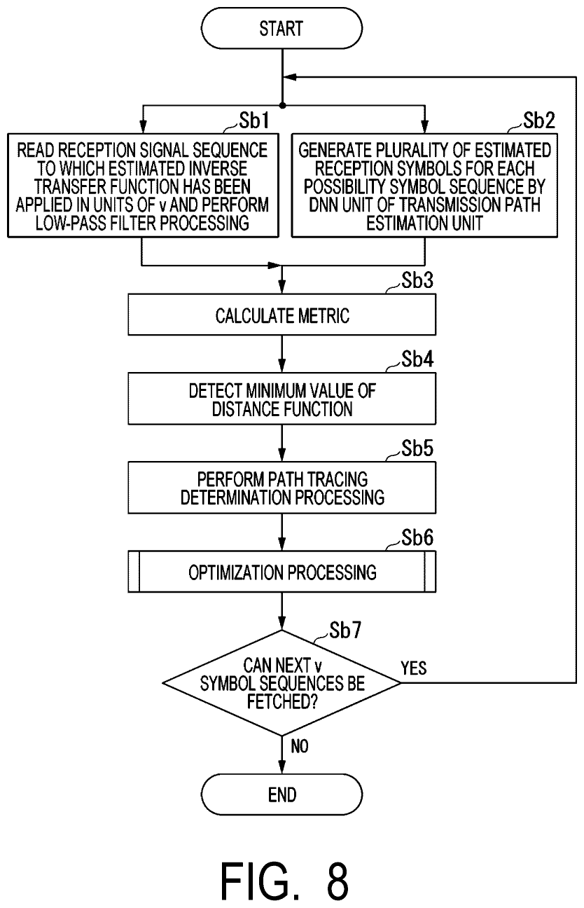

Next, processing performed in the first embodiment will be described with reference to FIGS. 7 to 9. FIG. 7 is a flowchart illustrating a flow of processing by the phase adjustment unit 30, and FIG. 8 is a flowchart illustrating a flow of processing by the maximum likelihood sequence estimation unit 40. Before the processing illustrated in FIG. 7 is started, the following is performed as initial setting.

For example, when the user of the communication system 1 connects a management terminal apparatus to the identification apparatus 4 and operates the management terminal apparatus, the following initial setting is performed on the adaptive filter unit 301, the low-pass filter unit 401, the DNN units 61 and 71, and the weight selection unit 406.

An initial value of an arbitrarily determined tap gain value is set in advance to the taps 33-1 to 33-u of the adaptive filter unit 301. An initial value of an arbitrarily determined tap gain value is set in advance to the taps 43-1 to 43-v of the low-pass filter unit 401.

Here, it is assumed that the sequence length of the possibility symbol sequence {s′ₜ} is p and the neural network 200 including the input layer nodes 210-1 to 210-p is provided in the DNN units 61 and 71. The numbers of the first intermediate layer nodes 220-1, 220-1, . . . and the second intermediate layer nodes 230-1, 230-2, . . . are predetermined appropriate numbers. Initial values of arbitrarily determined coefficients, that is, weights and biases are set for the first intermediate layer nodes 220-1, 220-1, . . . , the second intermediate layer nodes 230-1, 230-1, . . . , and the output layer node 240 of the neural network 200 included in the DNN unit 61 of the transmission path estimation unit 403. For example, a random number generated using a random number generator or the like is applied as the initial value of the coefficient. In the DNN unit 61 and the DNN unit 71, the initial value of the coefficient applied to the neural network 200 included in the DNN unit 61 is also set for the neural network 200 of the DNN unit 71 so that the same coefficient is applied in the initial state. The initial value of the coefficient set for the neural network 200 is written in advance in a region that is provided in the internal storage region of the learning processing unit 78 and stores the coefficient being applied.

The following information is written in the internal storage region of the weight selection unit 406. In other words, “ON” indicating that the weight selection processing is performed is written in a region of a weight selection flag that is provided in the internal storage region of the weight selection unit 406 and indicates whether or not the weight selection processing is performed. The initial value of the coefficient applied to the neural network 200 is written in a region that is provided in the internal storage region of the weight selection unit 406 and stores the coefficient being applied. The initial value of a predetermined weight threshold is written in a region that is provided in the internal storage region of the weight selection unit 406 and stores the weight threshold. A predetermined value is written in a region that is provided in the internal storage region of the weight selection unit 406 and stores a convergence determination value used for determining whether or not the weight is converged. A predetermined value is written in a region that is provided in the internal storage region of the weight selection unit 406 and stores a decrease width of the weight threshold. A predetermined value is written in a region that is provided in the internal storage region of the weight selection unit 406 and stores a synapse reduction upper limit value indicating an upper limit value for reducing synapses.

The user of the communication system 1 prepares in advance a random sequence having a long cycle capable of suppressing overtraining as a training m-value data sequence to be transmitted using the signal generation apparatus 3. Here, as a random sequence for suppressing overtraining, for example, a random sequence generated by Mersenne twister described in reference literature 1 below is applied. The training m-value data sequence is prepared in advance such that the sequence length of the training m-value data sequence, that is, the number of pieces of m-value data included in the training m-value data sequence becomes the number with which the coefficients applied to the DNN units 61 and 71 sufficiently converge.
[Reference Literature 1: Makoto Matsumoto and Takuji Nishimura, “Mersenne Twister: A 623-Dimensionally Equidistributed Uniform Pseudorandom Number Generator.” ACM Transactions on Modeling and Computer Simulation, 8(1):3-30. 1998.]

The user of the communication system 1 operates the management terminal apparatus to write the plurality of pieces of training m-value data prepared in advance in the training m-value data storage unit 73 of the optimization unit 404 so that the plurality of pieces of training m-value data can be read in the same order as the order of transmission by the signal generation apparatus 3 when sequentially reading from the head. The user of the communication system 1 operates the management terminal apparatus and writes the information indicating the training mode in the region that indicates the mode and is provided in the internal storage region of the input switching unit 74.

### Processing by Phase Adjustment Unit of First Embodiment

FIG. 7 is a flowchart illustrating a flow of processing by the phase adjustment unit 30 of the symbol determination unit 6. After the initial setting described above is completed, the user of the communication system 1 gives the training m-value data to the signal generation apparatus 3 in a predetermined order. The signal generation apparatus 3 generates the transmission signal sequence {sₜ} from the training m-value data sequence formed by arranging the given training m-value data in the given order, and sends the generated transmission signal sequence {sₜ} to the transmission path 2. As a result, the adaptive filter unit 301 of the phase adjustment unit 30 of the symbol determination unit 6 fetches the reception signal sequence {rₜ} corresponding to the training m-value data sequence.

The delayer 31 of the adaptive filter unit 301 fetches a symbol sequence having a sequence length u from the reception signal sequence {rₜ} (step Sa1). As described above, each of the delayer 31 and the delayers 32-1 to 32-(u−1) outputs the symbol sequence of the reception signal sequence {rₜ} in which the sequence length indicated by Formula (8) is limited to u, to the taps 33-1 to 33-u connected thereto. The taps 33-1 to 33-u multiply the symbols r_{t-(u-1)/2} to r_{t+(u-1)/2} given to the respective taps and the tap gain values f₁ to fᵤ set to the respective taps. As a result, the adaptive filter unit 301 performs calculation of substituting the symbol sequence (r_{t-(u-1)/2} to r_{t+(u-1)/2}) into the estimated inverse transfer function to obtain the output value of the estimated inverse transfer function.

The taps 33-1 to 33-u output the results of multiplication to the adder 34. The adder 34 sums the multiplication results to calculate the output value indicated by Formula (9), and outputs the output value to the provisional determination processing unit 302, the subtractor 36, and the low-pass filter unit 401 of the maximum likelihood sequence estimation unit 40. The signal sequence of the output value becomes the above-described output signal sequence {r′ₜ} (step Sa2).

The provisional determination processing unit 302 performs provisional determination of the transmission symbol by hard decision on the output value of the adaptive filter unit 301 and outputs the provisionally determined symbol as a provisional determination result (step Sa3).

The subtractor 36 outputs, as an error, a subtraction value obtained by subtracting the output value of the adaptive filter unit 301 from the provisionally determined symbol output from the provisional determination processing unit 302 to the filter update processing unit 35. The filter update processing unit 35 calculates the update values of the tap gain values f₁ to fᵤ by the LMS algorithm so as to reduce the error on the basis of the error output from the subtractor 36. The filter update processing unit 35 writes the calculated update values of the tap gain values f₁ to fᵤ to the taps 33-1 to 33-u and updates the tap gain values f₁ to fᵤ (step Sa4).

When the delayer 31 of the adaptive filter unit 301 can fetch, from the reception signal sequence {rₜ}, a symbol sequence having the sequence length u in a range obtained by shifting the range of the symbol sequence having the sequence length u fetched in the previous step Sa1 by one symbol (step Sa5, Yes), the processing of step Sa1 is performed again. On the other hand, when the delayer 31 cannot fetch, from the reception signal sequence {rₜ}, a symbol sequence having the sequence length u in a range obtained by shifting the range of the symbol sequence having the sequence length u fetched in the previous step Sa1 by one symbol (step Sa5, No), the processing ends.

### Processing by Maximum Likelihood Sequence Estimation Unit of First Embodiment

FIG. 8 is a flowchart illustrating a flow of processing by the maximum likelihood sequence estimation unit 40 of the symbol determination unit 6. The delayer 41 of the low-pass filter unit 401 fetches a symbol sequence having a sequence length v from the output signal sequence {r′ₜ} that is a sequence of output values output by the adder 34 of the adaptive filter unit 301 of the phase adjustment unit 30. As described above, each of the delayer 41 and the delayers 42-1 to 42-(v−1) outputs the symbol sequence of the output signal sequence {r′ₜ} in which the sequence length indicated by Formula (10) is limited to v, to the taps 43-1 to 43-v connected thereto.

The taps 43-1 to 43-v multiply the symbols r′_{t-(v-1)/2} to r′_{t+(v-1)/2} given to the respective taps and the tap gain values c₁ to cᵥ set to the respective taps, and output the results of multiplication to the adder 44. The adder 44 sums the multiplication results to calculate the output value indicated by Formula (11), that is, the determination target reception symbol. The adder 44 outputs the calculated determination target reception symbol to the subtractor 54 of the determination processing unit 402 (step Sb1).

In parallel with the processing of step Sb1, the possibility symbol sequence generation unit 405 generates the plurality of possibility symbol sequences {s′ₜ}. The possibility symbol sequence generation unit 405 outputs the generated plurality of possibility symbol sequences {s′ₜ} for each sequence to the addition comparison selection unit 52, the path tracing determination unit 51, and the transmission path estimation unit 403.

The possibility symbol sequence input unit 62 of the transmission path estimation unit 403 sequentially fetches the possibility symbol sequence {s′ₜ} output for each sequence by the possibility symbol sequence generation unit 405. The possibility symbol sequence input unit 62 outputs each of the plurality of possibility symbols included in the possibility symbol sequence {s′ₜ} to the corresponding input layer nodes 210-1 to 210-p of the DNN unit 61 according to the order of fetching. As a result, a sequence of symbols indicated on the right side of Formula (24) is given to the DNN unit 61 as an input sequence.

In the DNN unit 61, when each of the input layer nodes 210-1 to 210-p fetches an input sequence, the input sequence propagates through the first intermediate layer nodes 220-1, 220-2, . . . and the second intermediate layer nodes 230-1, 230-2, . . . in this order, and the output layer node 240 calculates an estimated reception symbol as an output value. The output layer node 240 outputs the calculated estimated reception symbol to the subtractor 54 (step Sb2).

The subtractor 54 subtracts each of the plurality of estimated reception symbols output by the DNN unit 61 of the transmission path estimation unit 403 from the determination target reception symbol included in the determination target reception symbol sequence output by the adder 44 of the low-pass filter unit 401 to calculate a plurality of subtraction values. The metric calculation unit 53 calculates a plurality of metrics by the calculation indicated by Formula (25), i.e., squaring an absolute value of each of the plurality of subtraction values output from the subtractor 54 (step Sb3).

The addition comparison selection unit 52 calculates a distance function dₜ ({μt}) corresponding to each of the plurality of metrics on the basis of the possibility symbol sequence {s′ₜ} output from the possibility symbol sequence generation unit 405 and the plurality of metrics output from the metric calculation unit 53. The addition comparison selection unit 52 detects a minimum value d_minₜ ({μₜ}) of the calculated distance function dₜ ({μₜ}) (step Sb4).

The path tracing determination unit 51 generates a path of the trellis on the basis of the possibility symbol sequence {s′ₜ} output by the possibility symbol sequence generation unit 405 and the minimum value d_minₜ ({1}) of the distance function dₜ ({μₜ}) detected by the addition comparison selection unit 52. The path tracing determination unit 51 traces the generated path of the trellis and specifies the estimated transmission symbol aₜ corresponding to the determination target reception symbol sequence (step Sb5).

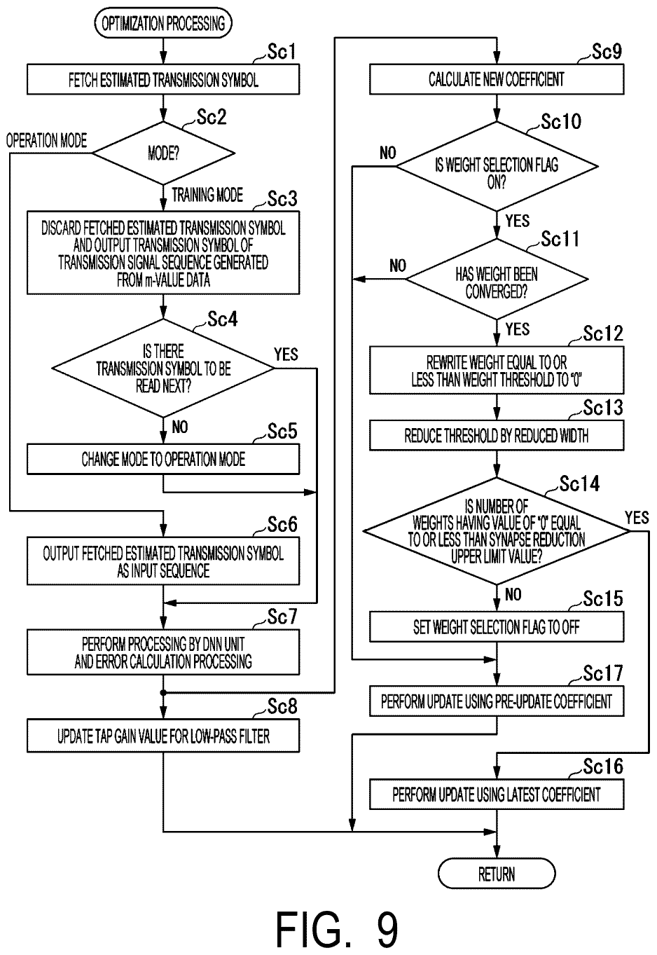

The input switching unit 74 of the optimization unit 404 fetches the estimated transmission symbol aₜ sequentially output by the path tracing determination unit 51. When the input switching unit 74 fetches the estimated transmission symbol aₜ, the subroutine of the optimization processing illustrated in FIG. 9 is started (step Sb6).

### (Optimization Processing by Optimization Unit)

The processing described below is performed by the input switching unit 74 until the processing of the subroutine in FIG. 9 is started. That is, when the initial setting described above is completed, the input switching unit 74 generates the transmission signal sequence {sₜ} from the training m-value data sequence stored in the training m-value data storage unit 73. The input switching unit 74 writes and stores the generated transmission signal sequence {sₜ} in the internal storage region. Note that when the input switching unit 74 is in the middle of generating the transmission signal sequence {sₜ} from the training m-value data sequence, a certain number of transmission symbols are stored in the internal storage region of the input switching unit 74. Therefore, while the input switching unit 74 is generating the transmission signal sequence {sₜ} from the training m-value data sequence, the processing in and after step Sc1 described below may be started.

When the estimated transmission symbol aₜ output by the path tracing determination unit 51 is fetched (step Sc1), the input switching unit 74 of the optimization unit 404 refers to the information indicating the mode stored in the internal storage region, and determines whether the information indicating the mode indicates the operation mode or the training mode (step Sc2). In the initial setting described above, since the information indicating the training mode is written as the information indicating the mode, here, the input switching unit 74 determines that the information indicating the mode indicates the training mode (step Sc2, training mode).

The input switching unit 74 discards the estimated transmission symbol aₜ fetched in the processing of step Sc1. The input switching unit 74 reads one head transmission symbol s_{L} of the transmission signal sequence {sₜ} stored in the internal storage region instead of the discarded estimated transmission symbol aₜ, and outputs the read transmission symbol to the DNN unit 71 and the delayer 72-1. After outputting the read transmission symbol sₜ, the input switching unit 74 deletes the head transmission symbol of the transmission signal sequence {sₜ} stored in the internal storage region, that is, the previously output transmission symbol sₜ.

In this case, the DNN unit 71 and the delayer 72-1 sequentially fetch the transmission symbols output from the input switching unit 74. The delayer 72-1 delays the fetched transmission symbol by one symbol and outputs the delayed transmission symbol. The delayers 72-2 to 72-(p−1) output a symbol one symbol after the transmission symbol output from a previous delayer 72-1 to 72-(p−2) connected thereto. As a result, after time (p−1)T/2 elapses since the input switching unit 74 fetches the estimated transmission symbol aₜ, the transmission signal sequence {sₜ} having the sequence length p of (s_{t-(p-1)/2}, . . . , sₜ, . . . , s_{t+(p-1)/2}) is given to the DNN unit 71 as the input sequence (step Sc3).

The input switching unit 74 refers to the internal storage region and determines whether or not a transmission symbol to be read next is included in the transmission signal sequence {sₜ}(step Sc4). When determining that the transmission symbol to be read next is not included in the transmission signal sequence {sₜ} (step Sc4, No), the input switching unit 74 rewrites the information indicating the mode in the internal storage region with the information indicating the operation mode (step Sc5). After the processing of step Sc5 or when the input switching unit 74 determines that the transmission signal sequence {sₜ} includes the transmission symbol to be read next in the processing of step Sc4 (step Sc4, Yes), the processing proceeds to step Sc7.

In the DNN unit 61, when each of the input layer nodes 210-1 to 210-p fetches an input sequence, the input sequence propagates through the first intermediate layer nodes 220-1, 220-2, . . . and the second intermediate layer nodes 230-1, 230-2, . . . in this order, and the output layer node 240 calculates an output value. The output value calculated by the output layer node 240 can be referred to as an estimated reception symbol obtained by substituting the transmission signal sequence {sₜ} having the sequence length p into the estimated transfer function (H′). The output layer node 240 outputs the calculated output value to the subtractor 77.

The delayer 76 fetches the output value output from the low-pass filter unit 401, that is, the determination target reception symbol, and outputs the fetched determination target reception symbol after a time of “wT+(p−1)T/2”, that is, a time of “w+(p−1)/2” symbol has elapsed to the subtractor 77. The subtractor 77 subtracts the output value output by the delayer 76 from the output value of the DNN unit 71, and outputs an error obtained by the subtraction to the filter update processing unit 75 and the learning processing unit 78 (step Sc7).

The filter update processing unit 75 calculates the update values of the tap gain values ci to cᵥ by the LMS algorithm so as to reduce the error on the basis of the error output from the subtractor 77. The filter update processing unit 75 sets the calculated update values of the tap gain values c₁ to cᵥ to the taps 43-1 to 43-v and updates the tap gain values c₁ to cᵥ (step Sc8), and ends the subroutine of the optimization processing.

In parallel with the processing of step Sc8, the learning processing unit 78 fetches the error output from the subtractor 77 and squares the fetched error to calculate a squared error. The learning processing unit 78 performs processing of calculating the new coefficient to be applied to the neural network 200 of the DNN units 61 and 71 so as to minimize the calculated squared error. More specifically, the learning processing unit 78 calculates the new coefficient to be applied to the neural network 200 by the error backpropagation method on the basis of the calculated squared error and the coefficient written in the region that stores the coefficient being applied in the internal storage region. The learning processing unit 78 rewrites the coefficient stored in the region for storing the coefficient being applied in the internal storage region to the calculated new coefficient, and outputs the calculated new coefficient to the weight selection unit 406. The weight selection unit 406 fetches the new coefficient output from the learning processing unit 78 (step Sc9).

The weight selection unit 406 refers to the internal storage region and determines whether or not the weight selection flag is “ON” (step Sc10). Since “ON” is written as the weight selection flag in the initial setting described above, the weight selection unit 406 determines that the weight selection flag is “ON” here (step Sc10, Yes). The weight selection unit 406 reads the coefficient from the region of the coefficient being applied in the internal storage region. The weight selection unit 406 compares each of the weights included in the read coefficient with each of the weights included in the fetched new coefficient, and determines whether or not the weights converge (step Sc11).

For example, the weight selection unit 406 calculates a squared error between each of the weights being applied and each of the currently fetched weights corresponding to each of the weights being applied. The weight selection unit 406 calculates a total error value by summing the calculated squared errors, and determines that convergence has occurred when the calculated total error value is equal to or less than a convergence determination value stored in the internal storage region.

When the weight selection unit 406 determines that the weights do not converge (step Sc11, No), the processing proceeds to step Sc17. On the other hand, when determining that the weights are converged (step Sc11, Yes), the weight selection unit 406 reads the weight threshold from the internal storage region, and rewrites the weight the absolute value of the fetched weight is equal to or less than the weight threshold to “0” (step Sc12).

The weight selection unit 406 reads the decrease width of the weight threshold from the internal storage region, subtracts a value corresponding to the decrease width of the weight threshold from the weight threshold, and overwrites with a new weight threshold obtained by the subtraction in the region storing the weight threshold provided in the internal storage region (step Sc13).

The weight selection unit 406 counts the number of weights the value of which is “0”. The weight selection unit 406 reads the synapse reduction upper limit value from the internal storage region, and determines whether the counted number is equal to or less than the synapse reduction upper limit value (step Sc14). When determining that the counted number is equal to or less than the synapse reduction upper limit value (step Sc14, Yes), the weight selection unit 406 rewrites the coefficient stored in the region for the coefficient being applied in the internal storage region to the latest coefficient. Here, the latest coefficient is a coefficient after the processing of step Sc12 is performed. The weight selection unit 406 sets the latest coefficient for the first intermediate layer nodes 220-1, 220-1, . . . , the second intermediate layer nodes 230-1, 230-1, . . . , and the output layer node 240 of the DNN units 61 and 71 corresponding thereto, and updates the coefficient. The weight selection unit 406 outputs the latest coefficient to the learning processing unit 78. The learning processing unit 78 fetches the latest coefficient output from the weight selection unit 406, rewrites the coefficient stored in the region of the coefficient being applied in the internal storage region to the fetched latest coefficient (step Sc16), and ends the subroutine of the optimization processing.

On the other hand, when determining that the counted number, that is, the number of weights the value of which is “0” is not equal to or less than the synapse reduction upper limit value in the processing of step Sc14 (step Sc14, No), the weight selection unit 406 assumes that the synapses have already been sufficiently reduced, and rewrites the weight selection flag in the internal storage region to “OFF” (step Sc15). The weight selection unit 406 rewrites the coefficient written in the region for storing the coefficient being applied in the internal storage region with the new coefficient fetched in the processing of step Sc9, that is, the new coefficient output by the learning processing unit 78. For example, it is assumed that, when the new coefficient output by the learning processing unit 78 is fetched in the processing of step Sc9, the weight selection unit 406 writes and stores the new coefficient for rewriting the weight in the processing of step Sc12 to “0” and the fetched original new coefficient in the internal storage region. The weight selection unit 406 sets the new coefficients fetched in the processing of step Sc9 for the first intermediate layer nodes 220-1, 220-1, . . . , the second intermediate layer nodes 230-1, 230-1, . . . , and the output layer node 240 of the DNN units 61 and 71 corresponding thereto, updates the coefficients (step Sc17), and ends the subroutine of the optimization processing.

In the subroutine of the optimization processing described above, the processing of step Sc5 is performed, and the input switching unit 74 rewrites the information indicating the mode in the internal storage region with the information indicating the operation mode. In this case, in the subroutine of the optimization processing to be performed again, the input switching unit 74 determines that the information indicating the mode in the internal storage region indicates the operation mode in the processing of step Sc2 (step Sc2, operation mode). In this case, when one estimated transmission symbol aₜ output by the path tracing determination unit 51 is fetched, the input switching unit 74 outputs the fetched estimated transmission symbol aₜ as it is to the DNN unit 71 and the delayer 72-1.

In this case, the DNN unit 71 and the delayer 72-1 sequentially fetch the estimated transmission symbol aₜ output from the input switching unit 74. The delayer 72-1 delays the fetched estimated transmission symbol aₜ by one symbol and outputs the delayed estimated transmission symbol. The delayers 72-2 to 72-(p−1) output a symbol one symbol after the estimated transmission symbol output from a previous delayer 72-1 to 72-(p−2) connected thereto. As a result, after time (p−1)T/2 elapses since the input switching unit 74 fetches the estimated transmission symbol aₜ, the estimated transmission signal sequence having the sequence length p of (a_{t-(p-1)/2}, . . . , aₜ, . . . , a_{t+(p-1)/2}) is given to the DNN unit 71 as the input sequence (step Sc6).

In the subroutine of the optimization processing described above, it is assumed that the processing of step Sc15 is performed and the weight selection unit 406 rewrites the weight selection flag in the internal storage region to “OFF”. In this case, in the subroutine of the optimization processing to be performed again, the weight selection unit 406 determines that the weight selection flag is “OFF” in the processing of step Sc10 (step Sc10, No), and the processing proceeds to step Sc17.

Returning to FIG. 8, when the delayer 41 of the low-pass filter unit 401 can fetch the symbol sequence having the sequence length v in a range obtained by shifting the range of the symbol sequence having the sequence length v fetched in the previous step Sb1 by one symbol from the output signal sequence {r′₁} output from the adaptive filter unit 301 of the phase adjustment unit 30 (step Sb7, Yes), the processing of steps Sb1 and Sb2 is performed again. On the other hand, when the delayer 41 cannot fetch, from the output signal sequence {r′ₜ} output from the adaptive filter unit 301 of the phase adjustment unit 30, a symbol sequence having the sequence length v in a range obtained by shifting the range of the symbol sequence having the sequence length v fetched in the previous step Sb1 by one symbol (step Sb7, No), the processing ends.

In the symbol determination unit 6 of the first embodiment described above, the possibility symbol sequence generation unit 405 generates a plurality of possibility symbol sequences that is possibilities for the transmission signal sequence formed by transmission symbols. The transmission path estimation unit 403 includes the neural network 200 that approximates the transfer function of the transmission path 2 that transmits a transmission signal sequence, and outputs an estimated reception symbol obtained as an output of the neural network 200 when each of the plurality of possibility symbol sequences is given to the neural network 200 as an input sequence. The determination processing unit 402 determines a transmission symbol by maximum likelihood sequence estimation on the basis of the determination target reception symbol sequence obtained from the reception signal sequence when the transmission path 2 transmits the transmission signal sequence and the estimated reception symbol for each possibility symbol sequence, thereby specifying an estimated transmission symbol corresponding to the determination target reception symbol sequence. When the transmission signal sequence transmitted when the reception signal sequence is received or the sequence obtained from the estimated transmission signal sequence formed by the estimated transmission symbol is given as an input sequence, the optimization unit 404 optimizes the neural network 200 so that the determination target reception symbol forming the determination target reception symbol sequence is obtained as an output. The neural network 200 enables calculation of repeating linear convolution and nonlinear calculation, and can express repetition of linear response and nonlinear response that are actual transmission path responses of the transmission path 2. Accordingly, by optimizing the neural network 200, it is possible to approximate a transfer function of an actual transmission path response, which is repetition of linear response and nonlinear response, with high accuracy in the NL-MLSE method.

In the symbol determination unit 6 of the first embodiment described above, the learning processing unit 78 sets each transmission signal sequence {sₜ} having the sequence length p extracted by shifting by one symbol from the transmission signal sequence {sₜ} generated from the training m-value data sequence prepared in advance as the input sequence of the DNN unit 71 in the training mode. The learning processing unit 78 performs the supervised learning processing using, as a correct answer label, the determination target reception symbol that is included in the determination target reception symbol sequence obtained in a case where the training m-value data sequence is transmitted and corresponds to the input sequence given to the DNN unit 71. By sufficiently converging the coefficient to an optimum state by the learning processing, the neural network 200 included in the DNN units 61 and 71 can perform calculation using the estimated transfer function (H′) with high approximation accuracy. After the training mode ends, the learning processing unit 78 gives the estimated transmission signal sequence {aₜ} having the sequence length p formed by the estimated transmission symbol output by the determination processing unit 402 to the DNN unit 71 as an input sequence, so that the coefficient of the neural network 200 included in the DNN units 61 and 71 can be adaptively updated even after operation. Therefore, even when a change occurs in the transmission path response in the transmission path 2, the estimated transfer function (H′) can be updated to an optimum state following the change.

In the technique disclosed in Non Patent Literature 1, the MLSE using a neural network in which an intermediate layer is one layer is indicated, and this solves a problem caused by nonlinear response at one place in a transmission path. On the other hand, the DNN units 61 and 71 of the first embodiment described above include the neural network 200 having at least two or more intermediate layers. In addition, the symbol determination unit 6 of the first embodiment includes the phase adjustment unit 30 and the low-pass filter unit 401 that are not indicated in Non Patent Literature 1. Therefore, unlike the technique disclosed in Non Patent Literature 1, the symbol determination unit 6 of the first embodiment can approximate a transfer function of an actual transmission path response that is repetition of linear response and nonlinear response with high accuracy.

In the first embodiment described above, overtraining is suppressed using a random sequence called Mersenne twister indicated in reference literature 1 as a training m-value data sequence. By the way, in a case where the tap gain value of the adaptive filter unit 301 is converged in advance, the sampling phases of the output signal sequence {r′ₜ} output by the phase adjustment unit 30 are aligned and stabilized, and thus, it is considered that the coefficients are likely to converge in the learning processing by the learning processing unit 78. Therefore, a random binary sequence of several hundred or about 1000 symbols may be inserted before the random sequence, and the tap gain value of the adaptive filter unit 301 may be first converged by the random binary sequence. In this case, after the tap gain value of the adaptive filter unit 301 converges, the tap gain value update processing by the update processing unit 303 is stopped, the tap gain value of the adaptive filter unit 301 is fixed, and in the fixed state, the learning processing unit 78 performs the learning processing with the random sequence following the random binary sequence.

In the neural network 200 included in the DNN units 61 and 71 of the symbol determination unit 6 of the first embodiment described above, synapses having small weight values have a small effect on the output value output by the output layer node 240, and even when synapses having small weight values are reduced, large performance degradation does not occur. Hence, the weight selection unit 406 in the symbol determination unit 6 rewrites the weight equal to or less than the weight threshold to “0” among the weights calculated by the learning processing unit 78 as described in the processing of step Sc12 described above. In the neural network 200, between the two neurons connected to the synapse the weight of which is “0”, the output value of the neurons in the preceding stage does not propagate to the neurons in the subsequent stage. As a result, since the calculation amount of the DNN units 61 and 71 is reduced, the calculation amount in the maximum likelihood sequence estimation can be reduced.

As indicated as the processing of step Sc13, the weight selection unit 406 repeatedly reduces the synapses having a small weight value while gradually reducing the weight threshold. In this way, by gradually reducing the weight threshold, the number of synapses to be reduced at a time is reduced, and performance degradation due to the reduction of synapses is moderated. Therefore, it is possible to optimize the weights of synapses to be finally used for calculation, that is, synapses remaining without being reduced. Note that, in the processing of step Sc13 described above, the decrease width of the weight threshold is set to a constant amount, but the decrease width of a plurality of weight thresholds may be set in advance, and the decrease width may be initially large and the decrease width may be small as the number of repetitions of step Sc13 increases.

As indicated as the processing of step Sc14, in a case where the number of weights the value of which is “0” exceeds the synapse reduction upper limit value, the weight selection unit 406 sets the weight selection flag to “OFF” so that the processing of reducing the synapses is not performed automatically. Such processing is performed because the processing of selecting the weight to be used only needs to be performed once before actual operation is performed. Note that, in a case where the weight converges at a value exceeding the weight threshold before the number of weights the value of which is “0” exceeds the synapse reduction upper limit value, the user of the communication system 1 connects the management terminal apparatus to the symbol determination unit 6 and operates the management terminal apparatus to rewrite the weight selection flag to “OFF”, so that the processing of forcibly reducing the synapse can be stopped and the state can be shifted to the operation state. In this case, it is also considered that the synapse reduction upper limit value is not appropriate. Therefore, for example, it is desirable to change the synapse reduction upper limit value to an appropriate value so that the processing of reducing the synapses is automatically stopped when the processing of periodically performing the processing of step Sc11 and the subsequent steps to bring the state of the neural network 200 into an optimum state is performed after the operation is started.

In a case where the configuration is changed, for example, by replacing the optical fiber 2-3 of the transmission path 2 after the operation is started, the user of the communication system 1 connects the management terminal apparatus to the symbol determination unit 6, operates the management terminal apparatus, and rewrites the weight selection flag to “ON”, so that the processing of reducing the synapses is performed again, and the number of synapses to which the weight other than “0” is applied can be brought into an optimum state. The weight selection unit 406 may include a timer and periodically rewrite a tap selection flag from “OFF” to “ON” by itself to perform the processing of reducing the synapses.

In the first embodiment described above, the phase adjustment unit 30 is provided at the preceding stage of the maximum likelihood sequence estimation unit 40, and the maximum likelihood sequence estimation unit 40 further includes the low-pass filter unit 401. On the other hand, when the sampling phases of the reception signal sequence {rₜ} are aligned, or when the memory length for storing the input sequence of the neural network 200, that is, the time indicated by the sequence length of the input sequence is longer than the impulse response time in the transmission path 2 to be estimated, the reception signal sequence {rₜ} fetched by the adaptive filter unit 301 of the phase adjustment unit 30 may be directly given to the subtractor 54 of the determination processing unit 402 and the delayer 76 of the optimization unit 404 without including the phase adjustment unit 30 and the low-pass filter unit 401.

However, in reality, there is a case where the sampling phases of the reception signal sequence {rₜ} are not aligned, and in a case where the phase condition of the reception signal sequence {rₜ} is not constant, the DNN units 61 and 71 are affected by the phase condition of the reception signal sequence {rₜ}, and it becomes difficult for the weight selection unit 406 to fix the synapses to be reduced.

By including the phase adjustment unit 30, the update processing unit 303 of the phase adjustment unit 30 calculates an error between the provisionally determined symbol output by the provisional determination processing unit 302 and the output value of the adaptive filter unit 301, and updates the estimated inverse transfer function so as to reduce the error by, for example, the least squares method. The phase of the output signal sequence output from the adaptive filter unit 301 that performs the calculation of the estimated inverse transfer function converged by the repeatedly performed update matches the phase of the sequence of the transmission symbol obtained by the provisional determination, and the sampling phases of the output signal sequence are aligned. The output signal sequence output from the adaptive filter unit 301 that performs the calculation of the estimated inverse transfer function converged by the repeatedly performed update can also suppress the ripple due to reflection or the like of the transmission path 2.

However, since the adaptive filter unit 301 of the phase adjustment unit 30 amplifies the high-frequency component decreased by the transmission path 2, the high-frequency component of white noise is also amplified. In order to suppress the high-frequency component of the white noise, in the first embodiment, the low-pass filter unit 401 is provided. The tap gain values c₁, c₂, . . . , c_{(v+1)/2}, . . . , and cᵥ of the low-pass filter unit 401 are updated by the filter update processing unit 75 with the output value of the DNN unit 71 as a target value at the same timing as the timing at which the new coefficient is applied to the DNN units 61 and 71. Therefore, by applying the low-pass filter unit 401 to the output signal sequence {r′ₜ} of the adaptive filter unit 301, it is possible to suppress the high-frequency component of the white noise amplified by the adaptive filter unit 301.

Note that, with the configuration of the first embodiment, the low-pass filter unit 401 performs the processing of compressing the pulse width in addition to the processing of suppressing the high-frequency component of the white noise. In the symbol determination unit 6 of the first embodiment, the adaptive filter unit 301 of the phase adjustment unit 30 and the low-pass filter unit 401 of the maximum likelihood sequence estimation unit 40 are configured to be connected. Therefore, the adaptive filter unit 301 of the phase adjustment unit 30 can be caused to perform the processing of compressing the pulse width. The performance of compressing the pulse width is improved as the number of taps is increased. Therefore, when causing the adaptive filter unit 301 of the phase adjustment unit 30 to perform the processing of compressing the pulse width, it is necessary to determine the number of u taps 33-1 to 33-u of the adaptive filter unit 301 of the phase adjustment unit 30 according to the required degree of compression of pulse width.

In a case where the adaptive filter unit 301 of the phase adjustment unit 30 is caused to perform the processing of compressing the pulse width, the low-pass filter unit 401 of the maximum likelihood sequence estimation unit 40 only needs to suppress the high-frequency component of the white noise. The ripple due to reflection or the like of the transmission path 2 has already been suppressed by the adaptive filter unit 301 of the phase adjustment unit 30. Therefore, the number of taps 43-1 to 43-v of the low-pass filter unit 401 can be reduced to reduce the scale of the low-pass filter unit 401. In this case, the condition of the value of v indicating the number of symbols fetched by the low-pass filter unit 401 is the number of symbols necessary to converge the coefficients applied to the DNN units 61 and 71.

In the first embodiment described above, the example is indicated in which a linear transversal filter is applied to the adaptive filter unit 301 of the phase adjustment unit 30 and the low-pass filter unit 401 of the maximum likelihood sequence estimation unit 40. On the other hand, a filter other than the linear transversal filter, such as another linear filter or nonlinear filter, may be applied to the adaptive filter unit 301 and the low-pass filter unit 401. Since the phase adjustment unit 30 only needs to be able to align the sampling phases, any circuit capable of aligning the sampling phases may be applied.

For example, in a case where the identification apparatus 4 includes a clock recovery circuit or the like that aligns the sampling phases of the reception signal sequence {rₜ} and is generally provided on the reception side, such a clock recovery circuit or the like may be regarded as the phase adjustment unit 30. In this case, when the high-frequency component of the white noise of the reception signal sequence {rₜ} with the aligned sampling phases is small, the reception signal sequence {rₜ} the sampling phases of which are aligned by the clock recovery circuit or the like may be configured to be directly given to the subtractor 54 of the determination processing unit 402 and the delayer 76 of the optimization unit 404 without including the low-pass filter unit 401.

### Second Embodiment

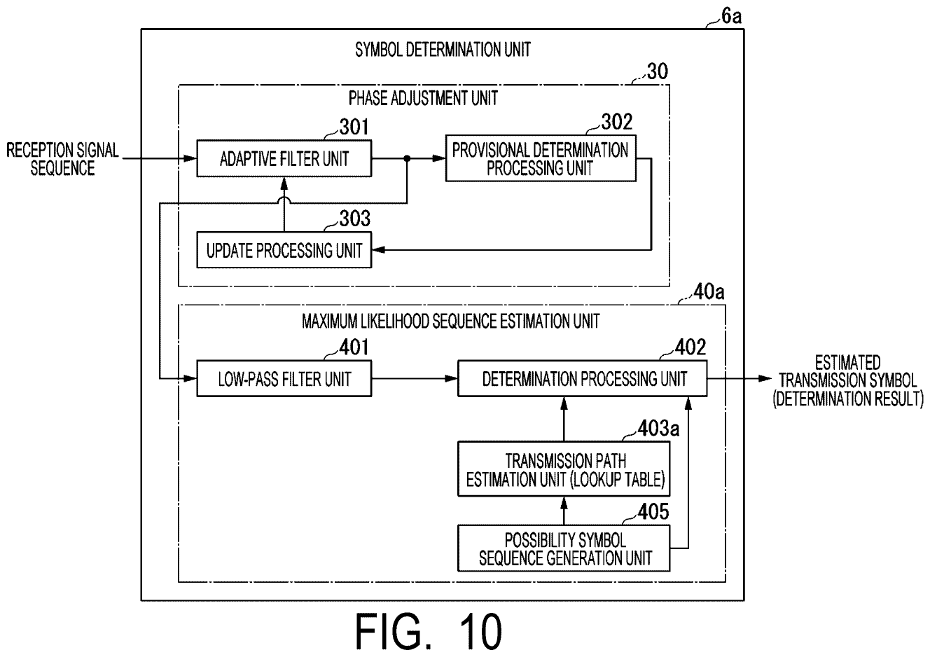

FIG. 10 is a block diagram illustrating a configuration of a symbol determination unit 6a according to the second embodiment. The symbol determination unit 6a is a functional unit used instead of the symbol determination unit 6 included in the identification apparatus 4 of the first embodiment, and is assumed to be used in a case where the transmission path response of the transmission path 2 is invariable. Hereinafter, for convenience of description, the identification apparatus 4 including the symbol determination unit 6a instead of the symbol determination unit 6 is referred to as an identification apparatus 4a, and the communication system 1 including the identification apparatus 4a instead of the identification apparatus 4 is referred to as a communication system 1a. In the second embodiment, the same configurations as those in the first embodiment are denoted by the same reference numerals, and different configurations will be described below.

As illustrated in FIG. 10, the symbol determination unit 6a includes a phase adjustment unit 30 and a maximum likelihood sequence estimation unit 40a. The maximum likelihood sequence estimation unit 40a includes a low-pass filter unit 401, a determination processing unit 402, a transmission path estimation unit 403a, and a possibility symbol sequence generation unit 405.

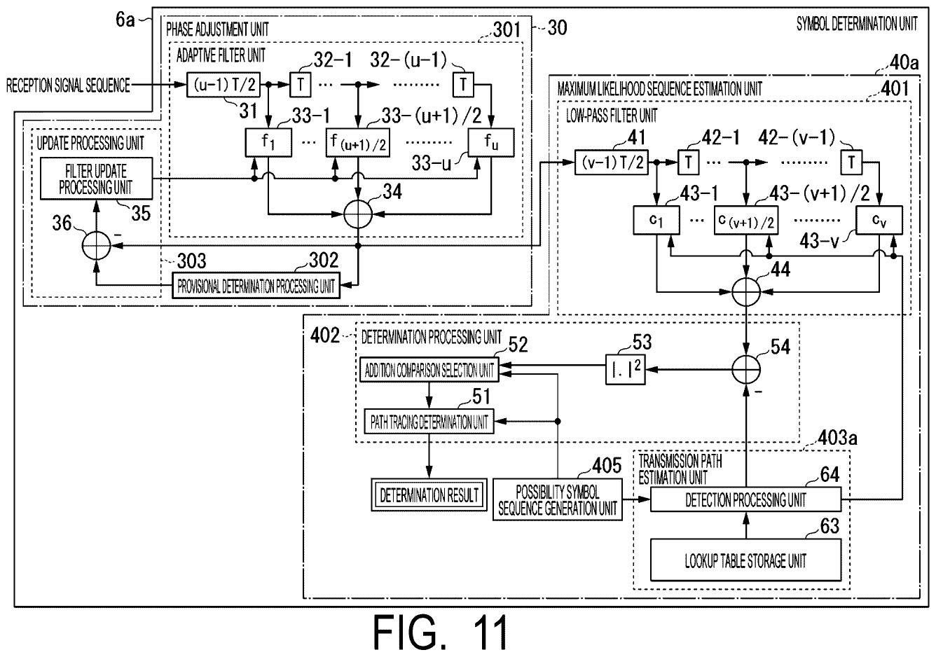

As illustrated in FIG. 11, the transmission path estimation unit 403a includes a lookup table storage unit 63 and a detection processing unit 64. The lookup table storage unit 63 stores data described below in advance.

When the transmission path response of the transmission path 2 is invariable, an estimated transfer function (H′) is also invariable. Therefore, in a case where the learned coefficient that is sufficiently converged is obtained by the learning processing performed by the learning processing unit 78 using the training in-value data sequence in the training mode of the symbol determination unit 6 of the first embodiment, it is not necessary to update the coefficient after the operation is started.

Hence, each of “m^{P}” possibility symbol sequences {s′ₜ} generated by the possibility symbol sequence generation unit 405 is given as an input sequence to the DNN unit 61 to which the learned coefficient is applied, thereby acquiring in advance an estimated reception symbol for each of the possibility symbol sequences {s′ₜ}. For each of “m^{P}” possibility symbol sequences {s′ₜ}, a lookup table associated with an estimated reception symbol corresponding to each possibility symbol sequence is generated in advance, and the generated lookup table is written and stored in the lookup table storage unit 63.

In a case where the transmission path response of the transmission path 2 is invariable, it is not necessary to update the tap gain value set for each of taps 43-1 to 43-v of a low-pass filter unit 401 when the training mode ends and after the operation is started. Therefore, when the training mode ends, the tap gain value set for each of the taps 43-1 to 43-v of the low-pass filter unit 401 is written and stored in the lookup table storage unit 63.

The detection processing unit 64 reads a plurality of tap gain values from the lookup table storage unit 63 and sets each of the plurality of read tap gain values to the corresponding one of the taps 43-1 to 43-v. Upon receiving the possibility symbol sequence {s′ₜ} from the possibility symbol sequence generation unit 405, the detection processing unit 64 refers to the lookup table stored in the lookup table storage unit 63, and detects an estimated reception symbol corresponding to the received possibility symbol sequence {s′ₜ}. The detection processing unit 64 outputs the detected estimated reception symbol to a subtractor 54. Note that, in a case where the possibility symbol sequence generation unit 405 is configured to output the symbols included in the possibility symbol sequence {s′ₜ} one symbol aₜ a time every time T, the sequence length p of the possibility symbol sequence {s′ₜ} is set in advance in the detection processing unit 64, and each time p symbols are received from the possibility symbol sequence generation unit 405, the p symbols are made into one sequence, and the estimated reception symbol is detected from the lookup table.

### Processing of Second Embodiment

Hereinafter, processing performed in the second embodiment will be described. For example, the user of the communication system 1a connects a management terminal apparatus to the identification apparatus 4a and operates the management terminal apparatus, and sets an initial value of an arbitrarily determined tap gain value in the taps 33-1 to 33-u of an adaptive filter unit 301 in advance as the initial setting in the second embodiment.

When the above initial setting is completed, the detection processing unit 64 of the transmission path estimation unit 403a reads a plurality of tap gain values from the lookup table storage unit 63 and sets each of the plurality of read tap gain values to the corresponding one of the taps 43-1 to 43-v of the low-pass filter unit 401.

As a result, the communication system 1a enters the operation state, and an m-value data sequence to be actually transmitted instead of the training m-value data sequence is given to the signal generation apparatus 3, and the adaptive filter unit 301 of the phase adjustment unit 30 of the symbol determination unit 6a fetches the reception signal sequence {rₜ} corresponding to the m-value data sequence.

In the processing by the phase adjustment unit 30 in the second embodiment, the same processing as the processing by the phase adjustment unit 30 in the first embodiment described with reference to FIG. 7 is performed.

### Processing by Maximum Likelihood Sequence Estimation Unit of Second Embodiment

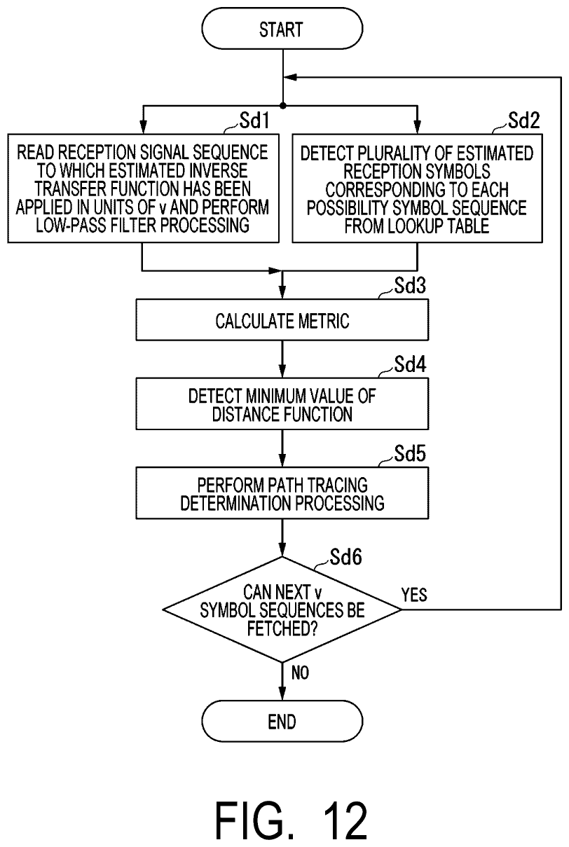

FIG. 12 is a flowchart illustrating a flow of processing by the maximum likelihood sequence estimation unit 40a of the symbol determination unit 6a. In the processing of step Sd1, the same processing as the processing of step Sb1 of FIG. 8 is performed by the low-pass filter unit 401. In parallel with the processing of step Sd1, the possibility symbol sequence generation unit 405 generates the plurality of possibility symbol sequences {s′ₜ}. The possibility symbol sequence generation unit 405 outputs the generated “m^{P}” possibility symbol sequences {s′ₜ} for each sequence to an addition comparison selection unit 52, a path tracing determination unit 51, and the detection processing unit 64.

When sequentially fetching the possibility symbol sequence {s′₁} output for each sequence by the possibility symbol sequence generation unit 405, the detection processing unit 64 detects an estimated reception symbol corresponding to the possibility symbol sequence {s′ₜ} from the lookup table stored in the lookup table storage unit 63 in order of fetching. The detection processing unit 64 outputs the detected estimated reception symbol to a subtractor 54 in order of detection (step Sd2).

Thereafter, in the processing of step Sd3, the same processing as that of step Sb3 in FIG. 8 is performed by the subtractor 54 and a metric calculation unit 53. In the processing of step Sd4, the same processing as that of step Sb4 of FIG. 8 is performed by the addition comparison selection unit 52. In the processing of step Sd5, the same processing as that of step Sb5 of FIG. 8 is performed by the path tracing determination unit 51. As a result, an estimated transmission symbol a_{L} can be obtained. In the processing of step Sd6, the same processing as that of step Sb7 of FIG. 8 is performed by the low-pass filter unit 401.

In the second embodiment described above, by using the lookup table stored in the lookup table storage unit 63, it is not necessary to use the DNN unit 61, and it is not necessary to include the optimization unit 404. Therefore, the apparatus scale of the symbol determination unit 6a in the identification apparatus 4a can be reduced. Since the neural network 200 is not used at the time of operation, it is possible to sequentially prevent an increase in the calculation amount, and thus, it is possible to expand the scale of the neural network 200 included in the DNN units 61 and 71 of the symbol determination unit 6 of the first embodiment used when generating the lookup table. Note that, in the second embodiment, it is assumed that the transmission path response of the transmission path 2 is invariable, but when time variation such as bias change of the reception signal sequence {rₜ} occurs, the time variation can be absorbed by the adaptive filter unit 301 of the phase adjustment unit 30.

In the second embodiment described above, as described in the first embodiment, in a case where the configuration not including the phase adjustment unit 30 and the low-pass filter unit 401 is adopted in the symbol determination unit 6 of the first embodiment, a similar configuration is also adopted in the symbol determination unit 6a of the second embodiment. Note that, in a case where the symbol determination unit 6 of the first embodiment does not include the low-pass filter unit 401, the lookup table storage unit 63 of the second embodiment does not need to store the tap gain value to be set for each of the taps 43-1 to 43-v of the low-pass filter unit 401, and the detection processing unit 64 also does not need to set the tap gain value for each of the taps 43-1 to 43-v of the low-pass filter unit 401 after completion of the initial setting.

### Third Embodiment

The method of converging and fixing the tap gain value of the adaptive filter unit 301 in advance using a random binary sequence in order for the coefficient to stably converge in the learning processing performed by the learning processing unit 78 of the first embodiment has been described. However, even when this method is adopted, the learning processing of updating the coefficient performed by the learning processing unit 78 and the processing of updating the tap gain value of the low-pass filter unit 401 by the filter update processing unit 75 are performed in parallel. When the tap gain value of the low-pass filter unit 401 is updated, the determination target reception symbol varies due to the update. The determination target reception symbol corresponds to a correct answer label in the supervised learning performed by the learning processing unit 78, and when the correct answer label varies, it becomes difficult to perform the supervised learning using a general machine learning library such as TensorFlow (registered trademark) or PyTorch.

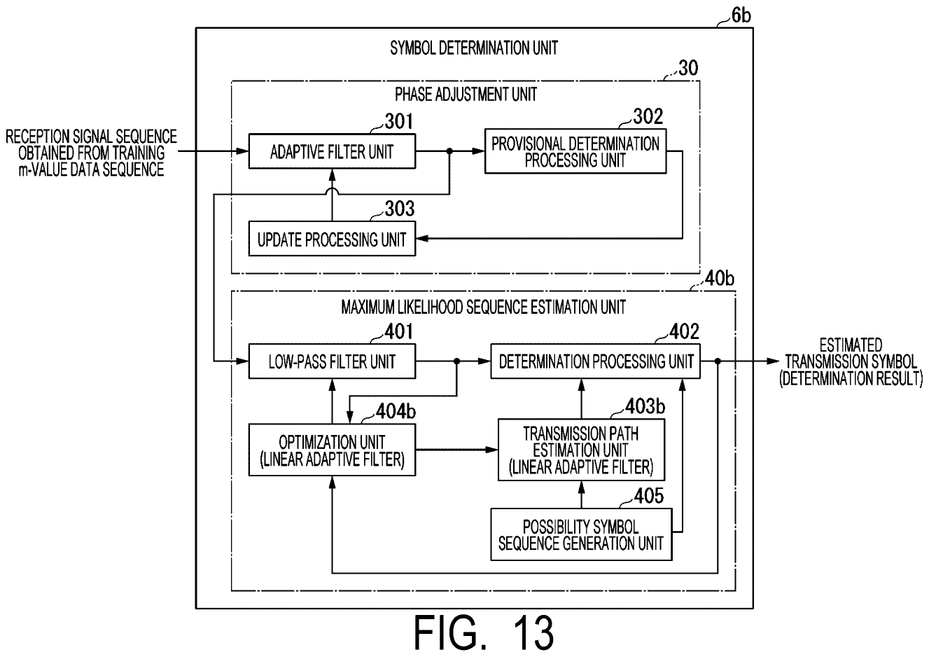

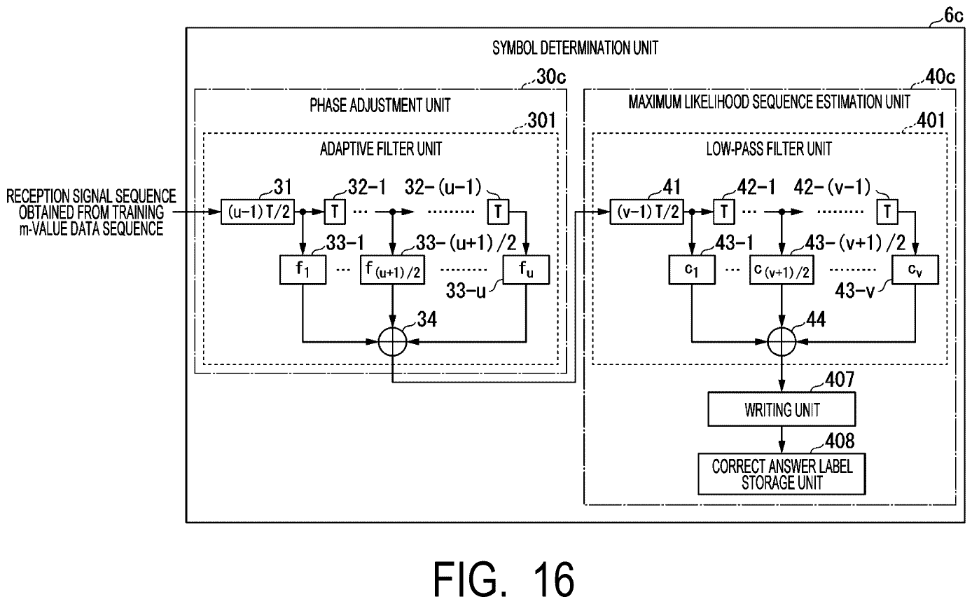

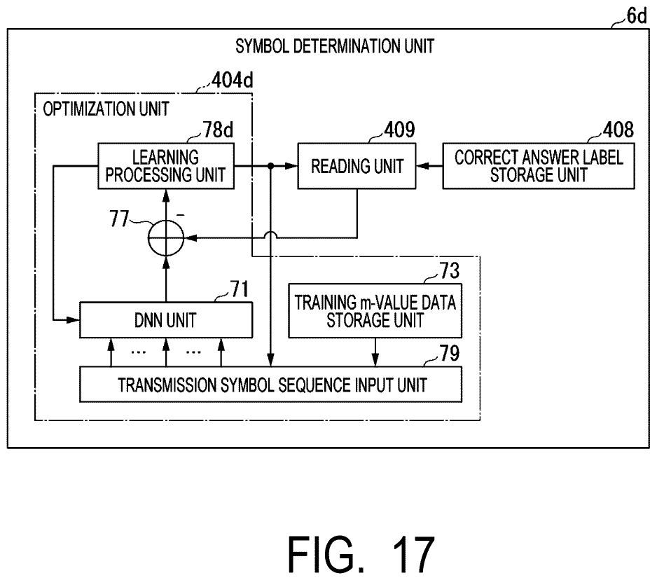

In the third embodiment, a configuration assuming use of a general machine learning library will be described. In the third embodiment, three types of configurations are used: a symbol determination unit 6b illustrated in FIG. 13, a symbol determination unit 6c illustrated in FIG. 16, and a symbol determination unit 6d illustrated in FIG. 17. Among them, the symbol determination unit 6d performs processing of supervised learning by applying a general machine learning library, and the symbol determination units 6b and 6c are used to generate in advance a correct answer label used in the processing of supervised learning.

Hereinafter, for convenience of description, the identification apparatus 4 including the symbol determination unit 6b instead of the symbol determination unit 6 is referred to as an identification apparatus 4b, and the communication system 1 including the identification apparatus 4b instead of the identification apparatus 4 is referred to as a communication system 1b. The identification apparatus 4 including the symbol determination unit 6c instead of the symbol determination unit 6 is referred to as an identification apparatus 4c, and the communication system 1 including the identification apparatus 4c instead of the identification apparatus 4 is referred to as a communication system 1c. The symbol determination unit 6d is not connected to a transmission path 2 and is used offline. In the third embodiment, the same configurations as those in the first and second embodiments are denoted by the same reference numerals, and configurations different from those of the first and second embodiments will be described.

### Configuration of Symbol Determination Unit 6b of Third Embodiment

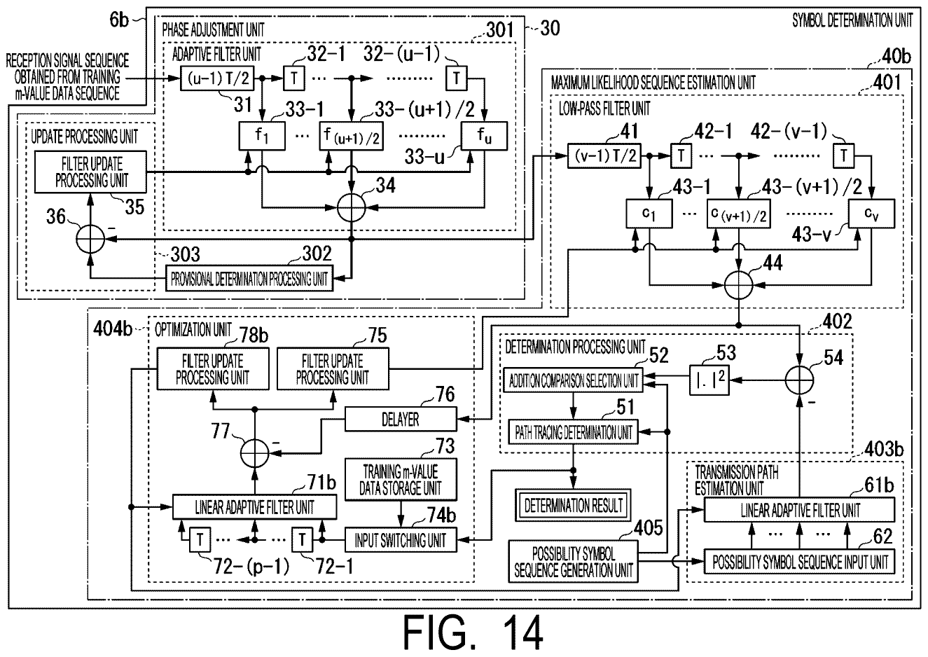

As illustrated in FIG. 13, the symbol determination unit 6b includes a phase adjustment unit 30 and a maximum likelihood sequence estimation unit 40b. The maximum likelihood sequence estimation unit 40b includes a low-pass filter unit 401, a determination processing unit 402, a transmission path estimation unit 403b, an optimization unit 404b, and a possibility symbol sequence generation unit 405. As illustrated in FIG. 14, the transmission path estimation unit 403b has a configuration in which the DNN unit 61 is replaced with a linear adaptive filter unit 61b in the transmission path estimation unit 403 of the first embodiment.

The optimization unit 404b has a configuration in which the DNN unit 71 is replaced with a linear adaptive filter unit 71b, the learning processing unit 78 is replaced with a filter update processing unit 78b, and the input switching unit 74 is replaced with an input switching unit 74b in the optimization unit 404 of the first embodiment. The linear adaptive filter unit 61b and the linear adaptive filter unit 71b have the same configuration. The linear adaptive filter units 61b and 71b are, for example, linear transversal filters similar to the adaptive filter unit 301 and the low-pass filter unit 401, and are small-scale linear adaptive filters in which the number of taps is the sequence length p of the possibility symbol sequence {s′_{L}} generated by the possibility symbol sequence generation unit 405.

The filter update processing unit 78b calculates the update values of the tap gain values applied to the taps included in the linear adaptive filter units 61b and 71b, for example, by the LMS algorithm so as to reduce the error on the basis of the error output from a subtractor 77. The filter update processing unit 78b sets each of the calculated update values of the tap gain values for the corresponding taps of the linear adaptive filter units 61b and 71b, and updates the tap gain values. The input switching unit 74b has the same configuration as the input switching unit 74 of the first embodiment except for the configuration in which when the information indicating the mode is the information indicating the operation mode or when there is no symbol to be output next, the processing of rewriting the information indicating the mode to the information indicating the operation mode is not performed and the processing ends.

### Processing in Case of Using Symbol Determination Unit 6b of Third Embodiment

Hereinafter, processing using the symbol determination unit 6b of the third embodiment will be described. When the user of the communication system 1b including the symbol determination unit 6b connects a management terminal apparatus to the identification apparatus 4b and operates the management terminal apparatus, for example, the following is performed as initial setting in the third embodiment. Initial values of arbitrarily determined tap gain values are set in advance for taps 33-1 to 33-u of the adaptive filter unit 301, the taps 43-1 to 43-v of the low-pass filter unit 401, and the taps of the linear adaptive filter units 61b and 71b. Note that an initial value is set for each of the taps of the linear adaptive filter units 61b and 71b so that the tap gain values of the taps are the same. A random binary sequence of several hundred or about 1000 symbols is written in advance as a training m-value data sequence in the training m-value data storage unit 73. Information indicating the training mode is written in advance in a region indicating the mode provided in the internal storage region of the input switching unit 74b.

When the above initial setting is completed, the user of the communication system 1b gives the same data sequence as the training m-value data sequence written in the training m-value data storage unit 73 to a signal generation apparatus 3. As a result, the adaptive filter unit 301 of the phase adjustment unit 30 of the symbol determination unit 6b fetches the reception signal sequence {rₜ} corresponding to the training in-value data sequence.

In the processing by the phase adjustment unit 30 in the third embodiment, the same processing as the processing by the phase adjustment unit 30 in the first embodiment described with reference to FIG. 7 is performed.

### Processing by Maximum Likelihood Sequence Estimation Unit of Third Embodiment

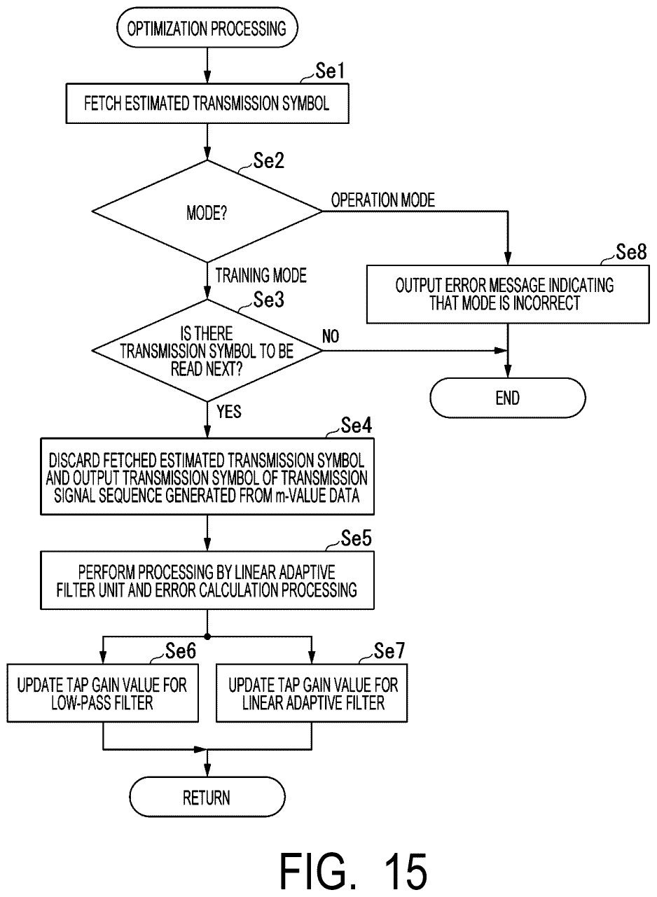

In the processing by the maximum likelihood sequence estimation unit 40b of the third embodiment, the same processing as the processing illustrated in FIG. 8 is performed except that in the processing by the maximum likelihood sequence estimation unit 40 of the first embodiment illustrated in FIG. 8, the subroutine of the optimization processing illustrated in FIG. 9 performed as the processing of step Sb6 is replaced with a subroutine of optimization processing illustrated in FIG. 15, and the processing of step Sb2 is replaced with the processing described below.

### Processing of Step Sb2 of Third Embodiment

In the third embodiment, the linear adaptive filter unit 61b is provided instead of the DNN unit 61. Therefore, in step Sb2, the following processing is performed. That is, in parallel with the processing of step Sb1, the possibility symbol sequence generation unit 405 generates the plurality of possibility symbol sequences {s′ₜ}. The possibility symbol sequence generation unit 405 outputs the generated plurality of possibility symbol sequences {s′ₜ} for each sequence to the addition comparison selection unit 52, the path tracing determination unit 51, and the transmission path estimation unit 403.

The possibility symbol sequence input unit 62 of the transmission path estimation unit 403 sequentially fetches the possibility symbol sequence {s′ₜ} output for each sequence by the possibility symbol sequence generation unit 405. The possibility symbol sequence input unit 62 outputs each of the plurality of possibility symbols included in the possibility symbol sequence {s′ₜ} to the corresponding taps of the linear adaptive filter unit 61b in order of fetching. As a result, a sequence of symbols indicated on the right side of Formula (24) is given to the linear adaptive filter unit 61b as an input sequence.

The linear adaptive filter unit 61b performs filtering processing of performing calculation of substituting an input sequence into an estimated transfer function (H′) indicated by the tap gain value set for the tap, and outputs an estimated reception symbol corresponding to each possibility symbol sequence {s′ₜ}. A subtractor 54 sequentially fetches a plurality of estimated reception symbols output from the linear adaptive filter unit 61b.

Thereafter, the processing of steps Sb3, Sb4, and Sb5 is performed, and in step Sb6, the subroutine of the optimization processing illustrated in FIG. 15 is started.

### Optimization Processing Performed in Step Sb6 of Third Embodiment

The subroutine of the optimization processing in the third embodiment will be described with reference to FIG. 15. Note that, similarly to the input switching unit 74 of the first embodiment, when the initial setting described above is completed, the input switching unit 74b generates a transmission signal sequence { }sₜ from the training m-value data sequence stored in the training m-value data storage unit 73, and writes and stores the generated transmission signal sequence {sₜ} in the internal storage region.

As the processing of steps Se1 and Se2, the same processing as the processing of steps Sc1 and Sc2 of FIG. 9 is performed. In the initial setting described above, since the information indicating the training mode is written as the information indicating the mode, here, the input switching unit 74b determines that the information indicating the mode indicates the training mode (step Se2, training mode).

The input switching unit 74b refers to the internal storage region and determines whether or not a transmission symbol to be read next is included in the transmission signal sequence {sₜ}(step Se3). When determining that the transmission signal sequence {sₜ} does not include the transmission symbol to be read next (step Se3, No), the input switching unit 74b ends the subroutine of the optimization processing.

On the other hand, when determining that the transmission signal sequence {sₜ} includes the transmission symbol to be read next (step Se3, Yes), the input switching unit 74b discards the estimated transmission symbol aₜ fetched in the processing of step Se1. The input switching unit 74b reads one head transmission symbol sₜ of the transmission signal sequence {sₜ} stored in the internal storage region instead of the discarded estimated transmission symbol aₜ, and outputs the read transmission symbol sₜ to the linear adaptive filter unit 71b and a delayer 72-1. After outputting the read transmission symbol, the input switching unit 74b deletes the head transmission symbol of the transmission signal sequence {sₜ} stored in the internal storage region, that is, the previously output transmission symbol s_{L}.

The linear adaptive filter unit 71b and the delayer 72-1 sequentially fetch the transmission symbols output from the input switching unit 74b. The delayer 72-1 delays the fetched transmission symbol sₜ by one symbol and outputs the delayed transmission symbol. The delayers 72-2 to 72-(p−1) output a symbol one symbol after the transmission symbol output from a previous delayer 72-1 to 72-(p−2) connected thereto. As a result, after time (p−1)T/2 elapses since the input switching unit 74b fetches the estimated transmission symbol aₜ, the transmission signal sequence {sₜ} having the sequence length p of (s_{t-(p-1)/2}, . . . , sₜ, . . . , s_{t+(p-1)/2}) is given to the linear adaptive filter unit 71b as the input sequence (step Se4).

The linear adaptive filter unit 71b performs filtering processing of performing calculation of substituting an input sequence into an estimated transfer function (H′) indicated by the tap gain value set for the tap, and outputs the output value. The subtractor 77 fetches the output value output from the linear adaptive filter unit 71b.

The delayer 76 fetches the output value output from the low-pass filter unit 401, that is, the determination target reception symbol, and outputs the fetched determination target reception symbol after a time of “wT+(p−1)T/2”, that is, a time of “w+(p−1)/2” symbol has elapsed to the subtractor 77. The subtractor 77 subtracts the output value output by the delayer 76 from the output value of the linear adaptive filter unit 71b, and outputs an error obtained by the subtraction to the filter update processing unit 75 and the filter update processing unit 78b (step Se5).

The filter update processing unit 75 calculates the update values of the tap gain values ci to cᵥ by the LMS algorithm so as to reduce the error on the basis of the error output from the subtractor 77. The filter update processing unit 75 sets the calculated update values of the tap gain values c₁ to cᵥ to the taps 43-1 to 43-v and updates the tap gain values c₁ to cᵥ (step Se6).

In parallel with the processing of step Se6, the filter update processing unit 78b calculates the update values of the tap gain values applied to the taps of the linear adaptive filter units 61b and 71b by the LMS algorithm so as to reduce the error on the basis of the error output from the subtractor 77. The filter update processing unit 78b sets each of the calculated update values of the tap gain values for the corresponding taps of the linear adaptive filter units 61b and 71b, and updates the tap gain values (step Se7). As a result, the subroutine of the optimization processing ends. Thereafter, the processing of step Sb7 illustrated in FIG. 8 is performed.

In step Se2 of the subroutine of the optimization processing illustrated in FIG. 15, the input switching unit 74b determines that the information indicating the mode indicates the operation mode (step Se2, operation mode). In this case, since there is an error in the initial setting, the input switching unit 74b outputs, for example, an error message indicating that the mode is incorrect to a display unit such as a display connected to the identification apparatus 4b (step Se8), and ends the processing.

When the processing by the symbol determination unit 6c described above ends, at that time point, sufficiently converged tap gain values are set for the taps 33-1 to 33-u of the adaptive filter unit 301 and the taps 43-1 to 43-v of the low-pass filter unit 401.

### Configuration of Symbol Determination Unit 6c of Third Embodiment

FIG. 16 is a block diagram illustrating a configuration of the symbol determination unit 6c. The symbol determination unit 6c includes a phase adjustment unit 30c and a maximum likelihood sequence estimation unit 40c. The phase adjustment unit 30c includes an adaptive filter unit 301. In each of the taps 33-1 to 33-u of the adaptive filter unit 301, a sufficiently converged tap gain value set for each of the taps 33-1 to 33-u of the adaptive filter unit 301 of the symbol determination unit 6b is set in advance at the time point when the processing by the symbol determination unit 6b described above is ended. Since the phase adjustment unit 30c does not include the update processing unit 303 unlike the phase adjustment unit 30, the tap gain values of the taps 33-1 to 33-u of the adaptive filter unit 301 are fixed.

The maximum likelihood sequence estimation unit 40c includes a low-pass filter unit 401, a writing unit 407, and a correct answer label storage unit 408. In each of the taps 43-1 to 43-v of the low-pass filter unit 401, a sufficiently converged tap gain value set for each of the taps 43-1 to 43-v of the low-pass filter unit 401 of the symbol determination unit 6b is set in advance at the time point when the processing by the symbol determination unit 6b described above is ended. Since the maximum likelihood sequence estimation unit 40c does not include the optimization unit 404b unlike the maximum likelihood sequence estimation unit 40b, the tap gain values of the taps 43-1 to 43-v of the low-pass filter unit 401 are fixed.

The writing unit 407 sequentially fetches the determination target reception symbol calculated and output by an adder 44 of the low-pass filter unit 401, and writes and stores the fetched determination target reception symbol in the correct answer label storage unit 408 in order of fetching.

### Processing in Case of Using Symbol Determination Unit 6c of Third Embodiment

A training m-value data sequence, which is a random sequence, generated by Mersenne twister, is prepared in advance. When the user of the communication system 1c gives the training m-value data sequence to the signal generation apparatus 3 of the communication system 1c including the symbol determination unit 6c, the phase adjustment unit 30c of the symbol determination unit 6c fetches the reception signal sequence {rₜ} corresponding to the training m-value data sequence. Since the provisional determination processing unit 302 and the update processing unit 303 are absent, the processing by the phase adjustment unit 30c becomes processing in which the processing of step Sa5 is performed after steps Sa1 and Sa2 in the processing by the phase adjustment unit 30 of the first embodiment illustrated in FIG. 7.

The low-pass filter unit 401 fetches the output signal sequence {r′ₜ} output from the phase adjustment unit 30c. The low-pass filter unit 401 performs the processing of steps Sb1 and Sb7 in the processing by the maximum likelihood sequence estimation unit 40 of the first embodiment illustrated in FIG. 8. The writing unit 407 sequentially fetches the determination target reception symbol output by the low-pass filter unit 401, and writes and stores the fetched determination target reception symbol in the correct answer label storage unit 408 in order. The writing unit 407 writes the determination target reception symbol in the correct answer label storage unit 408 so that reading can be performed in the same order as the order output by the low-pass filter unit 401 when reading is performed in order from the head. As a result, the correct answer label storage unit 408 stores the correct answer label of the output to be applied to the processing of the supervised learning performed with respect to the DNN units 61 and 71.

### Configuration of Symbol Determination Unit 6d of Third Embodiment

FIG. 17 is a block diagram illustrating a configuration of the symbol determination unit 6d. As described above, since the symbol determination unit 6d is used offline, the symbol determination unit 6d does not need to be connected to the transmission path 2. Therefore, the symbol determination unit 6d does not need to be provided in the identification apparatus 4, and can be operated as a single apparatus.

The symbol determination unit 6d includes an optimization unit 404d, the correct answer label storage unit 408, and a reading unit 409. The correct answer label storage unit 408 is the correct answer label storage unit 408 at the time point when the processing by the symbol determination unit 6c described above ends, and the determination target reception symbol sequence generated by the processing by the symbol determination unit 6c is written in the correct answer label storage unit 408. Every time a training instruction signal is received from a learning processing unit 78d, the reading unit 409 reads determination target reception symbols one by one in order from the head determination target reception symbol stored in the correct answer label storage unit 408, and outputs the read determination target reception symbol to the subtractor 77. That is, when receiving the first training instruction signal, the reading unit 409 reads one head determination target reception symbol stored in the correct answer label storage unit 408 and outputs the determination target reception symbol to the subtractor 77. When receiving the second training instruction signal, the reading unit 409 reads one determination target reception symbol, which is the second from the head, stored in the correct answer label storage unit 408 and outputs the determination target reception symbol to the subtractor 77. In this way, every time the training instruction signal is received from the learning processing unit 78d, the reading unit 409 reads the determination target reception symbol according to the number of times of receiving the training instruction signal from the correct answer label storage unit 408 and outputs the determination target reception symbol to the subtractor 77.

In still other words, it can be regarded that every time the training instruction signal is received, the reading unit 409 performs the same processing as outputting the determination target reception symbols included in the determination target reception symbol sequence generated by the symbol determination unit 6c described above to the subtractor 77 one by one in order from the head.

The optimization unit 404d includes the DNN unit 71, the training m-value data storage unit 73, a transmission symbol sequence input unit 79, the subtractor 77, and the learning processing unit 78d. In the training m-value data storage unit 73, the same m-value data sequence as the training m-value data sequence given to the signal generation apparatus 3 when the symbol determination unit 6c generates the determination target reception symbol sequence stored in the correct answer label storage unit 408 is written in advance.

Every time the training instruction signal is received from the learning processing unit 78d, the transmission symbol sequence input unit 79 generates a transmission signal sequence {sₜ} having the sequence length p from the training m-value data sequence stored in the training m-value data storage unit 73. The transmission symbol sequence input unit 79 gives the generated transmission signal sequence {sₜ} having the sequence length p to the DNN unit 71 as an input sequence.

For example, it is assumed that, when the reading unit 409 receives a k-th training instruction signal, the correct answer label read from the correct answer label storage unit 408 is the determination target reception symbol corresponding to time t on the time axis of the transmission signal sequence {sₜ}. Herein, k is an integer of 1 or more. In this case, the transmission symbol sequence input unit 79 generates the transmission signal sequence {sₜ} from the training m-value data sequence in advance, and when receiving the k-th training instruction signal, extracts the transmission signal sequence (s_{t-(p-1)/2}, . . . , sₜ, . . . , s_{t+(p-1)/2}) having the sequence length p centered on the transmission symbol sₜ at time t from the generated transmission signal sequence {sₜ} to set the extracted transmission signal sequence as the k-th input sequence. In this way, every time the training instruction signal is received from the learning processing unit 78d, the transmission symbol sequence input unit 79 extracts a sequence having the sequence length p according to the number of times of receiving the training instruction signal from the transmission signal sequence {sₜ} generated from the training m-value data sequence and sets the extracted sequence as an input sequence.

In other words, upon receiving the training instruction signal from the learning processing unit 78d, the transmission signal sequence (s_{t-(p-1)/2}, . . . , sₜ, . . . , s_{t+(p-1)/2}) having the sequence length p generated by the transmission symbol sequence input unit 79 matches the portion of the transmission signal sequence {sₜ} having the sequence length p sent from the signal generation apparatus 3 to the transmission path 2 when the symbol determination unit 6c generates the determination target reception symbol that is output as the correct answer label by the reading unit 409 at the timing of the training instruction signal. Accordingly, the combination of the determination target reception symbol and the transmission signal sequence (s_{t-(p-1)/2}, . . . , sₜ, . . . , s_{t+(p-1)/2}) having the sequence length p in the correspondence relationship can be referred to as training data with a correct answer label used when performing supervised learning in the neural network 200 included in the DNN unit 71. Note that, in a case where there is a deviation on the time axis between the transmission signal sequence (s_{t-(p-1)/2}, . . . , sₜ, . . . , s_{t+(p-1)/2}) having the sequence length p generated by the transmission symbol sequence input unit 79 and the determination target reception symbol sequence that is the sequence of the correct answer label, the deviation can be detected in advance using a cross-correlation function. In a case where there is a deviation, the transmission symbol sequence input unit 79 outputs the generated transmission signal sequence (s_{t-(p-1)/2}, . . . , sₜ, . . . , s_{t+(p-1)/2}) having the sequence length p to the DNN unit 71 at a timing at which the deviation detected in advance is taken into consideration.

The subtractor 77 subtracts the determination target reception symbol output by the reading unit 409 from the output value of the DNN unit 71, and outputs an error obtained by the subtraction to the learning processing unit 78d. The learning processing unit 78d calculates new coefficients, that is, weights and biases, to be applied to the DNN unit 71, for example, by the error backpropagation method so as to minimize the error output from the subtractor 77.

### Processing by Symbol Determination Unit 6d of Third Embodiment

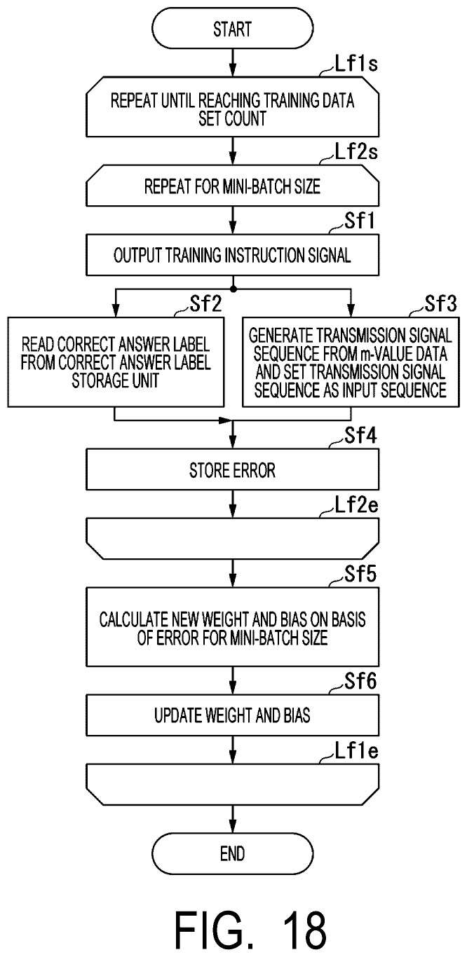

FIG. 18 is a flowchart illustrating a flow of processing by the symbol determination unit 6d. In the internal storage region of the learning processing unit 78d, a region for storing four parameters: mini-batch size, mini-batch counter, mini-batch processing repetition count, and mini-batch processing counter is provided.

Before the processing of FIG. 18 is started, for example, the user of the symbol determination unit 6d connects the management terminal apparatus to the symbol determination unit 6d and operates the management terminal apparatus, and the initial setting described below is performed. For example, it is assumed that 10,000 correct answer labels are stored in the correct answer label storage unit 408. In this case, as an example, “100” is written in advance to the mini-batch size, and “100” is written in advance to the mini-batch processing repetition count. The mini-batch counter and the mini-batch processing counter are initialized to “0”. As in the first embodiment, initial values of coefficients are set for the neural network 200 of the DNN unit 71. The initial value of the coefficient set for the neural network 200 is written in advance in a region that is provided in the internal storage region of the learning processing unit 78d and stores the coefficient being applied.

When the initial setting described above is completed, the transmission symbol sequence input unit 79 generates the transmission signal sequence {sₜ} from the training m-value data sequence stored in the training m-value data storage unit 73. The transmission symbol sequence input unit 79 writes and stores the generated transmission signal sequence {sₜ} in the internal storage region.

The learning processing unit 78d outputs the training instruction signal to the reading unit 409 and the transmission symbol sequence input unit 79 (step Sf1). Upon receiving the training instruction signal, the reading unit 409 reads the correct answer label according to the number of times of receiving the training instruction signal from the correct answer label storage unit 408 and outputs the correct answer label to the subtractor 77 (step Sf2).

In parallel with the processing of step Sf2, when receiving the training instruction signal, the transmission symbol sequence input unit 79 extracts the transmission signal sequence (s_{t-(p-1)/2}, . . . , sₜ, . . . , s_{t+(p-1)/2}) having the sequence length p according to the number of times of receiving the training instruction signal from the transmission signal sequence {sₜ} stored in the internal storage region, and sets the extracted transmission signal sequence as an input sequence. The transmission symbol sequence input unit 79 outputs each of the p transmission symbols included in the generated input sequence to corresponding input layer nodes 210-1 to 210-p. As a result, an output layer node 240 of the neural network 200 included in the DNN unit 71 calculates the output value and outputs the calculated output value to the subtractor 77 (step Sf3).

The subtractor 77 subtracts the value indicated by the correct answer label output by the reading unit 409 from the output value of the DNN unit 71 to calculate an error, and outputs the calculated error to the learning processing unit 78d. The learning processing unit 78d fetches the error output from the subtractor 77, and writes and stores the fetched error in the internal storage region. The learning processing unit 78d sets a value obtained by adding 1 to the value indicated by the mini-batch counter in the internal storage region as a new value of the mini-batch counter in the internal storage region (step Sf4).

The learning processing unit 78d repeats the processing of steps Sf1 to Sf4 until the value of the mini-batch counter in the internal storage region reaches the value indicated by the mini-batch size in the internal storage region (loops Lf2s to Lf2e).

When the value of the mini-batch counter in the internal storage region reaches “100”, that is, the value indicated by the mini-batch size in the internal storage region, the learning processing unit 78d reads a number of errors matching the mini-batch size stored in the internal storage region, that is, 100 errors, and the coefficient of the neural network 200 stored in the internal storage region. The learning processing unit 78d performs processing of calculating a new coefficient to be applied to the neural network 200 of the DNN unit 71 so as to minimize a sum of squared errors that is a sum of values obtained by squaring each of the read 100 errors. More specifically, the learning processing unit 78d calculates a new coefficient to be applied to the neural network 200 by the error backpropagation method on the basis of the calculated sum of squared errors and the coefficient being applied to the neural network 200 written in the region that stores the coefficient being applied in the internal storage region (step Sf5).

The learning processing unit 78d initializes the value of the mini-batch counter in the internal storage region to “0”. The learning processing unit 78d sets a value obtained by adding 1 to the value indicated by the mini-batch processing counter in the internal storage region as a new value of the mini-batch processing counter in the internal storage region. The learning processing unit 78d rewrites the coefficient stored in the region that stores the coefficient being applied in the internal storage region with the calculated new coefficient and sets the new coefficient for the neural network 200 of the DNN unit 71 so as to update the coefficient (step Sf6).

The learning processing unit 78d repeats the processing of loops Lf2s to Lf2e and steps Sf5 and Sf6 until the value of the mini-batch processing counter in the internal storage region reaches the value indicated by the mini-batch processing repetition count in the internal storage region (loops Lf1s to Lf1e).

When the value of the mini-batch processing counter in the internal storage region reaches “100”, that is, the value indicated by the mini-batch processing repetition count in the internal storage region, the learning processing unit 78d ends the processing. As a result, when the number of combinations included in the training data with the correct answer label is a sufficient number to converge the coefficient of the DNN unit 71, the neural network 200 that calculates the estimated transfer function (H′) with high approximation accuracy is constructed in the DNN unit 71 when the processing of FIG. 18 ends.

Since the above learning processing is a general supervised learning processing performed using training data with a correct answer label that is a combination of a plurality of input sequences and correct answer labels corresponding to the respective input sequences, it can be implemented using a general machine learning library. The above learning processing is learning processing by a so-called mini-batch gradient descent method, and is learning processing included in a general machine learning library.

The coefficient applied to the neural network 200 of the DNN unit 71 at the time point when the processing of FIG. 18 ends is applied to, for example, the DNN units 61 and 71 of the symbol determination unit 6 of the first embodiment, and is written in the region for storing the coefficient being applied in the internal storage region of the learning processing unit 78. Then, by setting the information indicating the mode in the internal storage region of the input switching unit 74 to the information indicating the operation mode, the symbol determination unit 6 can bring the communication system 1 into the operation state without performing the learning processing using the training m-value data sequence that requires a long time. In this case, the tap gain values set for the taps 33-1 to 33-u of the adaptive filter unit 301 and the tap gain values set for the taps 43-1 to 43-v of the low-pass filter unit 401 may be the values at the time of the initial setting described in the first embodiment, or may be the tap gain values set for the taps 33-1 to 33-u of the adaptive filter unit 301 and the taps 43-1 to 43-v of the low-pass filter unit 401 of the symbol determination unit 6c of the third embodiment.

The lookup table to be stored in the lookup table storage unit 63 of the symbol determination unit 6a of the second embodiment may be generated using the neural network 200 of the DNN unit 71 at the time point when the processing of FIG. 18 ends. In this case, the tap gain values set for the taps 43-1 to 43-v of the low-pass filter unit 401 of the symbol determination unit 6c of the third embodiment are set as the tap gain values of the taps 43-1 to 43-v of the low-pass filter unit 401 to be written in advance in the lookup table storage unit 63. Note that the tap gain values set for the taps 33-1 to 33-u of the adaptive filter unit 301 of the symbol determination unit 6a may be the values at the time of the initial setting described in the second embodiment, or may be the tap gain values set for the taps 33-1 to 33-u of the adaptive filter unit 301 of the symbol determination unit 6c of the third embodiment.

Note that, as described in the first embodiment, when the sampling phases of the reception signal sequence {rₜ} are aligned, or when the memory length for storing the input sequence of the neural network 200, that is, the time indicated by the sequence length of the input sequence is longer than the impulse response time in the transmission path 2 to be estimated, it is not necessary to include the phase adjustment unit 30 and the low-pass filter unit 401. In this case, it is not necessary to use the symbol determination units 6b and 6c of the third embodiment described above, and by applying the correct answer label storage unit 408 in which the reception signal sequence received {rₜ} output from the reception unit 5 is written to the symbol determination unit 6d, it is possible to perform the supervised learning processing.

### Fourth Embodiment

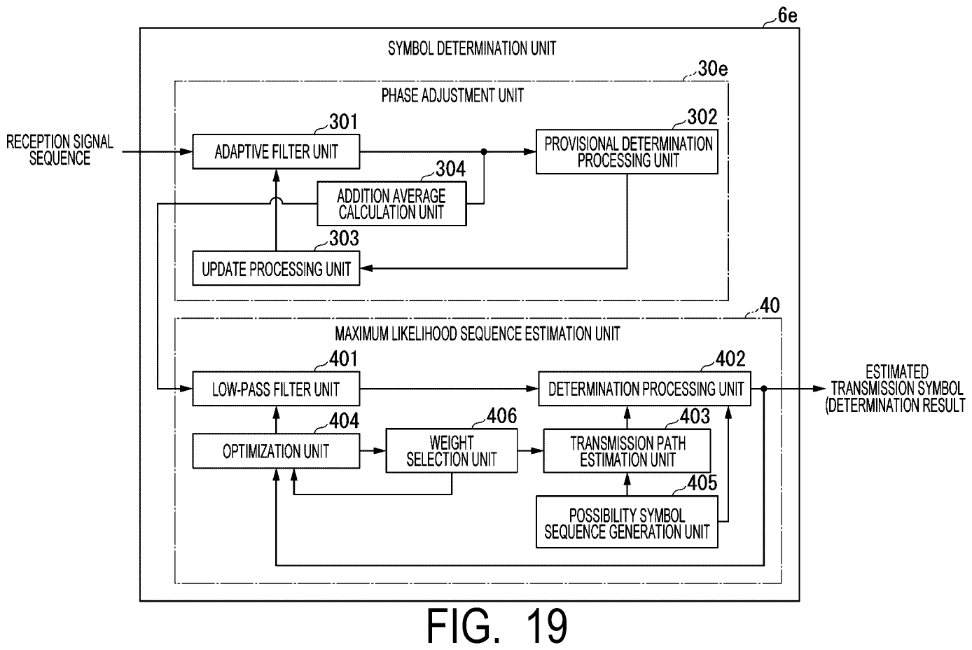

FIG. 19 is a block diagram illustrating a configuration of a symbol determination unit 6e according to the fourth embodiment. Hereinafter, for convenience of description, the identification apparatus 4 including the symbol determination unit 6e instead of the symbol determination unit 6 is referred to as an identification apparatus 4e, and the communication system 1 including the identification apparatus 4e instead of the identification apparatus 4 is referred to as a communication system 1e. In the fourth embodiment, the same configurations as those in the first to third embodiments are denoted by the same reference numerals, and different configurations will be described below.

The symbol determination unit 6e includes a phase adjustment unit 30e and a maximum likelihood sequence estimation unit 40. The phase adjustment unit 30e includes an adaptive filter unit 301, a provisional determination processing unit 302, an update processing unit 303, and an addition average calculation unit 304.

The addition average calculation unit 304 is connected to the adaptive filter unit 301, more specifically, is connected to an adder 34 of the adaptive filter unit 301, and fetches the output value indicated by Formula (9) output by the adder 34. The addition average calculation unit 304 adds and averages the output values output from the adder 34 and outputs the result to a low-pass filter unit 401 of the maximum likelihood sequence estimation unit 40.

### Processing by Phase Adjustment Unit of Fourth Embodiment

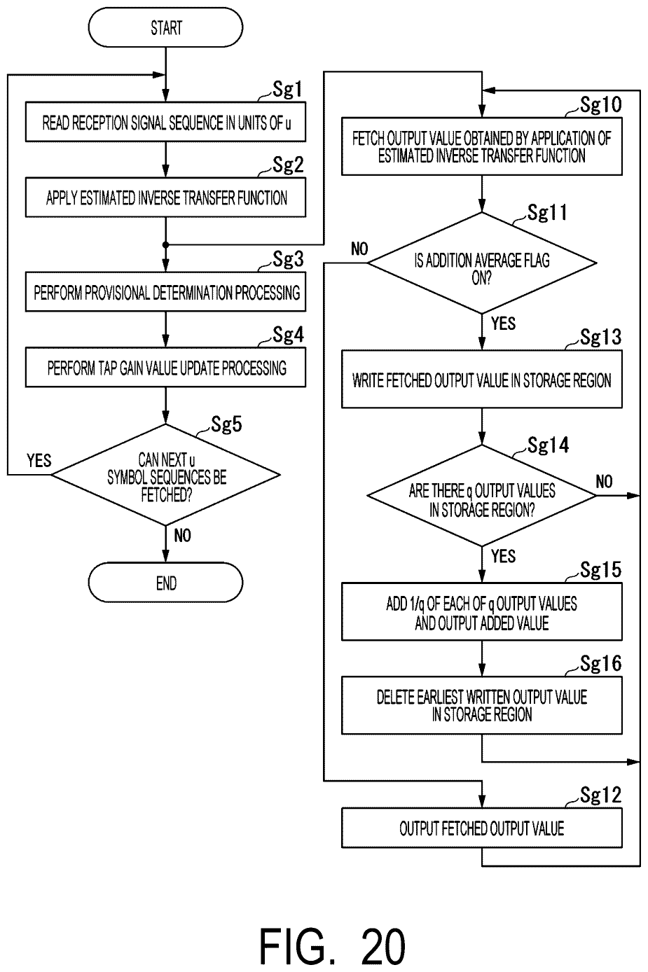

FIG. 20 is a flowchart illustrating a flow of processing by the phase adjustment unit 30e of the symbol determination unit 6e. As preprocessing of the processing of the flowchart illustrated in FIG. 20, for example, the user of the communication system 1e connects the management terminal apparatus to the identification apparatus 4e and operates the management terminal apparatus, so that the same initial setting as that of the first embodiment is performed and the initial setting described below is further performed. “ON” is written in a region that is provided in the internal storage region of the addition average calculation unit 304 and for an addition average flag indicating whether or not to perform the processing of the addition averaging. A value “q” indicating a predetermined number of times of addition averaging is written in a region of the number of times of addition averaging provided in the internal storage region of the addition average calculation unit 304. Herein, q is an integer of 2 or more.

In the processing of steps Sg1 to Sg5, the same processing as steps Sa1 to Sa5 of the first embodiment illustrated in FIG. 7 is performed by the adaptive filter unit 301, the provisional determination processing unit 302, and the update processing unit 303.

The addition average calculation unit 304 fetches the output value indicated by Formula (9) output by the adder 34 of the adaptive filter unit 301 in the processing of step Sg2 (step Sg10). The addition average calculation unit 304 refers to the internal storage region and determines whether or not the addition average flag is “ON” (step Sg11). When determining that the addition average flag is not “ON” (step Sg11, No), the addition average calculation unit 304 outputs the fetched output value to the low-pass filter unit 401 of the maximum likelihood sequence estimation unit 40 (step Sg12), and performs the processing of step Sg10 again.

On the other hand, when determining that the addition average flag is “ON” (step Sg11, Yes), the addition average calculation unit 304 writes the fetched output value into the internal storage region (step Sg13). The addition average calculation unit 304 reads the number of times of addition averaging q from the internal storage region. The addition average calculation unit 304 determines whether or not q output values exist in the internal storage region (step Sg14). When determining that q output values do not exist in the internal storage region (step Sg14, No), the addition average calculation unit 304 performs the processing of step Sg10 again.

On the other hand, when determining that q output values exist in the internal storage region (step Sg14, Yes), the addition average calculation unit 304 adds the values of 1/q of the respective values of the q output values to calculate an output value obtained by addition averaging. The addition average calculation unit 304 outputs the output value obtained by the addition averaging to the low-pass filter unit 401 of the maximum likelihood sequence estimation unit 40 (step Sg15). The addition average calculation unit 304 deletes the earliest written, i.e., the oldest output value, from the internal storage region (step Sg16), and performs the processing of step Sg10 again.

The symbol determination unit 6e of the fourth embodiment described above includes the addition average calculation unit 304, thereby having the effects described below in addition to the effects of the symbol determination unit 6 of the first embodiment. For example, by transmitting the transmission signal sequence {sₜ} generated from the predetermined training m-value data sequence before operation from the signal generation apparatus 3, the addition average calculation unit 304 can perform so-called ensemble averaging. That is, the addition average calculation unit 304 can generate a training output signal sequence {r′₁} in which white noise is suppressed by adding and averaging the reception signal sequence {rₜ} with the aligned sampling phases. The learning processing unit 78 of the maximum likelihood sequence estimation unit 40 converges coefficients applied to the DNN units 61 and 71 by learning processing on the basis of the training output signal sequence {r′ₜ} generated by the addition average calculation unit 304, and a weight selection unit 406 performs processing of reducing synapses of the neural network 200 included in the DNN units 61 and 71. As a result, the weight selection unit 406 can perform the processing of reducing synapses in a state where the effect of the white noise is reduced. Therefore, even in a state where the tap gain value of the low-pass filter unit 401 that suppresses the high-frequency component of the white noise does not converge, it is possible to obtain the determination target reception symbol sequence with a low effect of the white noise and with the aligned sampling phases, so that it is possible to extract synapses that have a large effect on indicating the estimated transfer function (H′) more quickly and with higher accuracy. In a case where the extraction of the synapse is completed and the transition to the operation state is made, the user of the communication system 1e operates the management terminal apparatus and writes “OFF” in the region of the addition average flag provided in the internal storage region of the addition average calculation unit 304, so that the processing of steps Sg13 to Sg16 can be prevented from being performed.

### (Result of Experiment Using Experimental System)

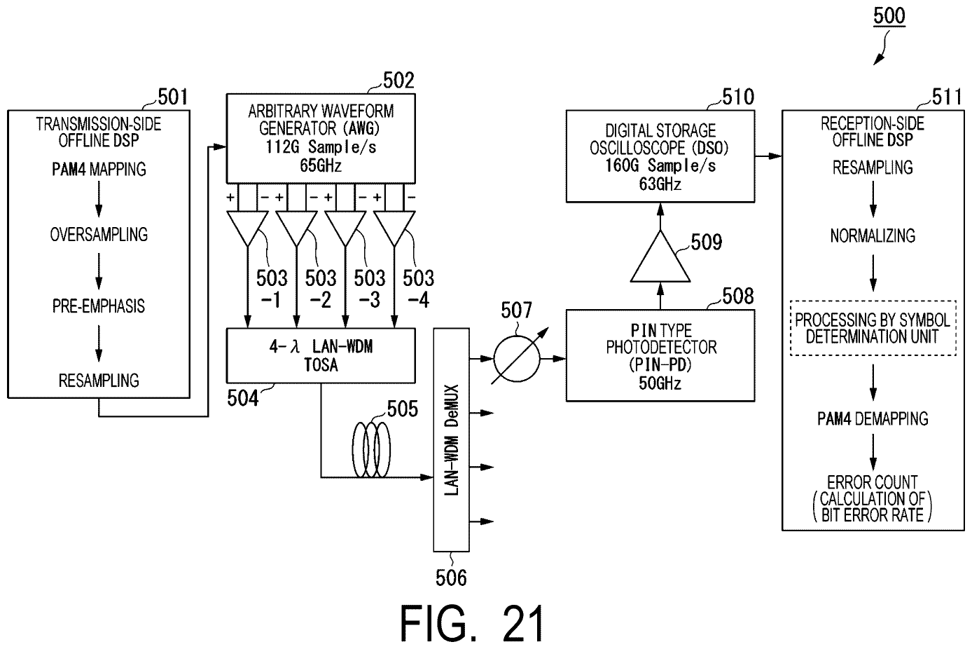

FIG. 21 is a block diagram illustrating a configuration of a communication system 500 used to measure an effect by the symbol determination unit 6 of the first embodiment. The communication system 500 is an experimental system that performs an O-band optical transmission experiment of 224 Gbps, PAM4, 2 km, and 4 ch, and includes a transmission-side offline DSP 501, an arbitrary waveform generator (hereinafter, referred to as an “AWG”) 502, amplifiers 503-1 to 503-4, a transmitter optical sub-assembly (TOSA) 504, an optical fiber transmission path 505, a de-multiplexer (DeMUX) 506, a variable optical attenuator (hereinafter, referred to as “VOA”) 507, a PIN type photodiode (hereinafter referred to as “PIN-PD”) 508, an amplifier 509, a digital storage oscilloscope (hereinafter, referred to as a “DSO”) 510, and a reception-side offline DSP 511.

The transmission-side offline DSP 501 performs PAM4 mapping, oversampling, pre-emphasis, and resampling on transmission data to generate an m-value data sequence in which m=4. The AWG 502 has performance of 112 GSample/s and 65 GHz, fetches the m-value data sequence generated by the transmission-side offline DSP 501, and generates and outputs four transmission signal sequences on the basis of the fetched m-value data sequence. Each of the amplifiers 503-1 to 503-4 amplifies each of the four transmission signal sequences output by the AWG 502. The TOSA is a TOSA for 4-k local area network (LAN)-wave division multiplexing (WDM), converts each of the transmission signal sequences output from the amplifiers 503-1 to 503-4 into an optical signal of four different wavelengths, wavelength-multiplexes the converted optical signal of the four wavelengths, and sends the optical signal to the optical fiber transmission path 505.

The optical fiber transmission path 505 is a standard single mode fiber (SSMF) having a length of 2 km and a wavelength dispersion amount at a wavelength of 1295 nm of −4.2 ps/nm, and transmits the wavelength-multiplexed optical signal sent from the TOSA 504. The DeMUX 506 is a DeMUX for LAN-WDM, demultiplexes the optical signal of the four wavelengths transmitted from the optical fiber transmission path 505, and outputs each of the demultiplexed optical signals from four output interfaces.

The VOA 507 is switched and connected to any one of the four output interfaces of the DeMUX 506, and adjusts the power of the optical signal received through the connected output interface. The PIN-PD 508 has performance of a cutoff frequency of 50 GHz, and converts the intensity-modulated modulated light into a reception signal sequence of an analog electric signal by the direct detection method. The amplifier 509 amplifies and outputs the reception signal sequence of the analog electric signal output from the PIN-PD 508. The DSO 510 has performance of 160 GSample/s and 63 GHz, fetches the reception signal sequence of the analog electric signal output from the amplifier 509, and converts the reception signal sequence into the reception signal sequence of a digital signal.

The reception-side offline DSP 511 fetches the reception signal sequence of the digital electric signal generated through the conversion by the DSO 510. The reception-side offline DSP 511 performs resampling and normalizing on the reception signal sequence fetched from the DSO 510, specifies the estimated transmission symbol with the symbol determination unit 6, performs PAM4 demapping, and restores the m-value data sequence. The reception-side offline DSP 511 calculates a bit error rate of the restored m-value data sequence.

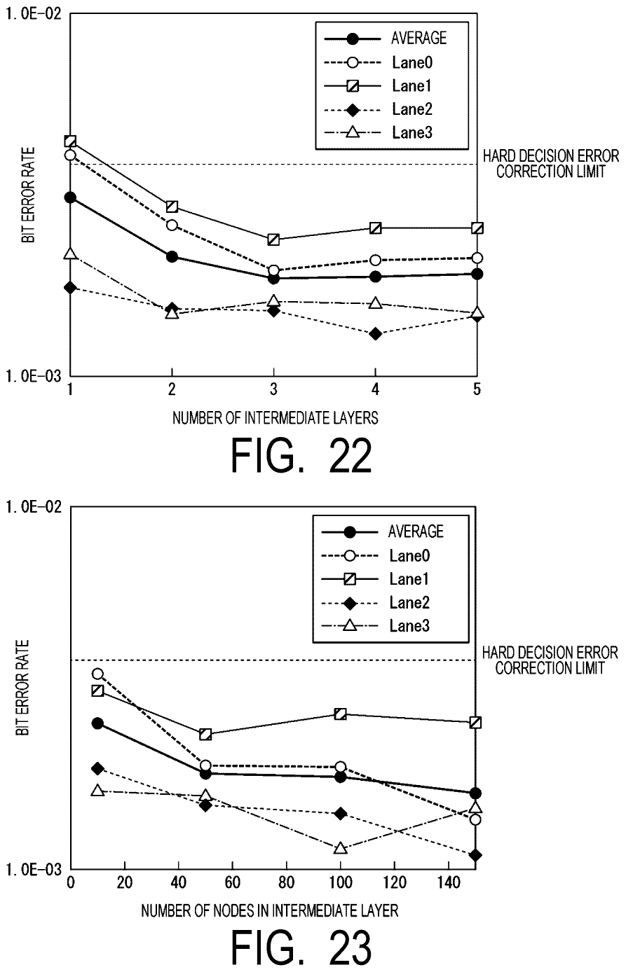

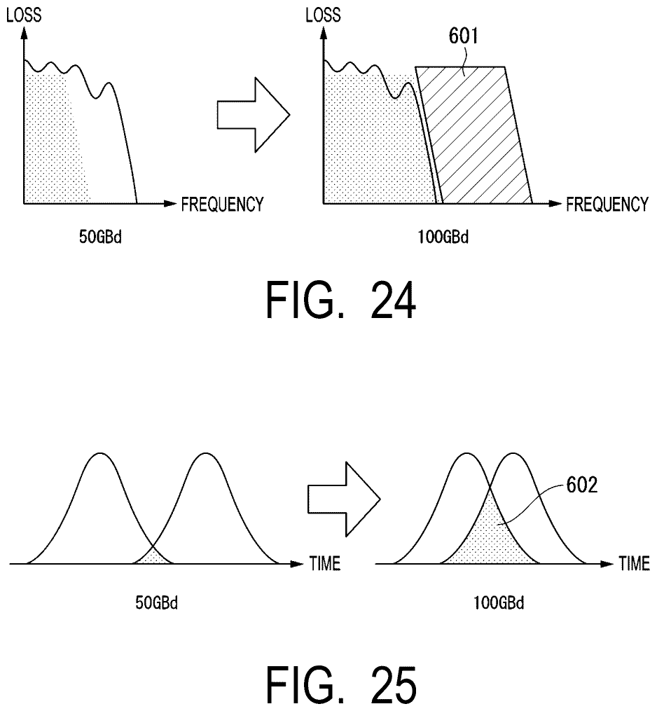

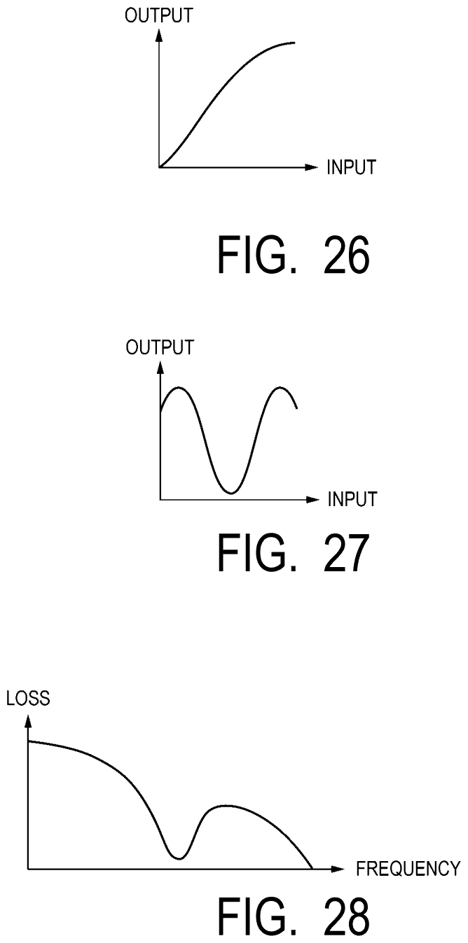

FIG. 22 is a graph illustrating a relationship between the bit error rate calculated by the reception-side offline DSP 511 and the number of intermediate layers of the neural network 200 of the DNN units 61 and 71 of the symbol determination unit 6. As a measurement condition when the graph of FIG. 22 is obtained, the number of intermediate layer nodes of each intermediate layer of the neural network 200 of the DNN units 61 and 71 of the symbol determination unit 6 is set to 50. For example, when the number of intermediate layers is two, the total number of intermediate layer nodes is 100. In addition, the power of the optical signal received by the PIN-PD 508 is set to 2 dBm by the VOA 507.

In FIG. 22, the dotted line parallel to the horizontal axis indicates a “hard decision error correction limit”. Here, the “hard decision error correction limit” is an error rate indicating transmission performance that enables sufficient error correction when forward error correction (FEC) of hard decision is used, and is an index for measuring performance of signal processing such as of the MLSE. As illustrated in the legend, the five graph types in FIG. 22 include four graphs indicated by four types of marks: white circle “◯”, square “□”, diamond “⋄”, and triangle “Δ”, the four graphs being graphs of measurement results obtained by measuring the optical signals obtained from each of the four output interfaces of the DeMUX 506, and the graph of black circle “●” being a graph indicating an average value of the four graphs.

As can be seen from FIG. 22, when the number of intermediate layers becomes two or more, the bit error rate becomes lower than the hard decision error correction limit. It can be seen that the bit error rate decreases and the transmission performance is improved as the number of intermediate layers increases. However, in a case where the number of intermediate layers is three or more, since the learning processing of the neural network 200 is not stably performed, the bit error rate may be improved or may not be improved. Therefore, in the graph of the average indicated by the black circle “●”, it can be seen that when the number of intermediate layers exceeds three layers, only a bit error rate substantially the same as the bit error rate in the case of the three layers is obtained.

FIG. 23 is a graph illustrating a relationship between the bit error rate calculated by the reception-side offline DSP 511 and the number of nodes in the intermediate layer of the neural network 200 of the DNN units 61 and 71 of the symbol determination unit 6. As a measurement condition when the graph of FIG. 23 is obtained, the number of intermediate layers of the neural network 200 of the DNN units 61 and 71 of the symbol determination unit 6 is three, and the power of the optical signal received by the PIN-PD 508 is 2 dBm by the VOA 507. In FIG. 23, the dotted line parallel to the horizontal axis indicates a “hard decision error correction limit” similarly to FIG. 22, and the meanings of the five marks indicating the types of graphs are the same as those in FIG. 22.

As can be seen from the graph of FIG. 23, in a case where the number of nodes in the intermediate layer is ten or more, the bit error rate is lower than the hard decision error correction limit in any case. It can be seen that the bit error rate decreases and the transmission performance is improved as the number of nodes in the intermediate layer increases. In particular, a noticeable improvement is obtained when the number of nodes in the intermediate layer is between 10 and 50, but it can be seen that a large improvement is not obtained when the number exceeds 50 as indicated by the graph of the average indicated by the black circle “●”.

### Supplementary Matters of Embodiments

The configuration of the neural network 200 indicated in the first to fourth embodiments described above is an example, and as long as it is a function approximator that approximates the transfer function (H) of the transmission path 2 and performs the calculation of the estimated transfer function (H′), the neural network may have another configuration, and a machine learning method other than the neural network may be used.

In the first to fourth embodiments described above, the activation function of the neural network 200 is the ReLU function indicated by Formula (13), but for example, a sigmoid function indicated by Formula (27) described below may be applied, or other activation functions may be applied. Note that, in Formula (27), α is a gain, and a value larger than 0 is determined in advance.

$$\begin{matrix}[ Math . 27 ] & \\ f ( x ) = \frac{1}{1 + {e}^{- α x}} & ( 27 )\end{matrix}$$

For example, as an activation function other than the ReLU function and the sigmoid function, a function indicated by Formula (28) described below derived from the content described in reference literature 2 below may be applied.

$$\begin{matrix}[ Math . 28 ] & \\ f ( x ) = \sqrt{( 1 - β ) + β \cdot x} \cdot exp ( \frac{j γ}{2} log [ ( 1 - β ) + β \cdot x ] ) & ( 28 )\end{matrix}$$

[Reference Literature 2: F. Koyama and K. Iga, “Frequency chirping in external modulators”, in Journal of Lightwave Technology, vol. 6, no. 1, pp. 87-93, January 1988, doi: 10.1109/50.3969]

In Formula (28) described above, β is a modulation degree of the intensity modulator 2-2 of the transmission path 2, and is a value of 0 or more and 1 or less. The value of β indicates what signal having what amplitude is a signal to be modulated by the intensity modulator 2-2 when a range between the minimum power and the maximum power across which a change can be made by the intensity modulator 2-2 is normalized by 1. Basically, the minimum amplitude level of the signal to be modulated is 1−β, and the maximum amplitude level is 1. By changing the modulation degree β, it is possible to perform adjustment such as whether modulation is performed in a region where the response of the intensity modulator 2-2 maintains linearity or whether a large amplitude is secured so as to make a nonlinear response but reduce the effect of noise. In Formula (28), γ is a chirp factor in the intensity modulator 2-2, and is a parameter indicating the degree of occurrence of different phase modulation for each modulation frequency. As can be seen from Formula (28), the modulation degree p and the chirp factor γ have roles like hyperparameters in some sort of nonlinear function. Accordingly, by applying the actual modulation degree 0 and the chirp factor γ of the intensity modulator 2-2 of the transmission path 2 to the parameters of the activation function of Formula (28), Formula (28) can be made into an activation function in which the input/output characteristics of the components constituting the transmission path 2 are taken into consideration. By applying such an activation function to the neural network 200, it is possible to construct a neural network in consideration of the theoretical response characteristics of the components constituting the transmission path 2, and it is possible to improve the accuracy of extraction of a feature amount as compared with the case of using the ReLU function or the sigmoid function, so that it is possible to obtain the estimated transfer function (H′) with high approximation accuracy.

The processing of supervised learning indicated in the first embodiment described above is a stochastic gradient descent method of calculating a new coefficient every time one error is obtained, but instead of this, a mini-batch gradient descent method of calculating a new coefficient on the basis of a plurality of errors obtained for each mini-batch indicated in the third embodiment may be applied. By using the mini-batch gradient descent method, the frequency of updating the coefficient of the neural network 200 is reduced as compared with the stochastic gradient descent method, and thus, it is possible to reduce the calculation amount and to perform stable supervised learning processing while suppressing the effect of outliers. In the first embodiment, the stochastic gradient descent method may be applied in the training mode, and the mini-batch gradient descent method may be applied in the operation mode, and conversely, the mini-batch gradient descent method may be applied in the training mode, and the stochastic gradient descent method may be applied in the operation mode. In the third embodiment, the stochastic gradient descent method of calculating a new coefficient every time one error is obtained as indicated in the first embodiment may be applied. Similarly to the mini-batch gradient descent method, the stochastic gradient descent method is learning processing included in a general machine learning library. In the first and third embodiments, when the mini-batch gradient descent method is applied, the mini-batch size indicated in the third embodiment is an example, and an appropriate number may be determined as appropriate. As a method applied to the processing of supervised learning of the first and third embodiments, a method other than the stochastic gradient descent method and the mini-batch gradient descent method may be applied.

As the error generation function, in the first embodiment described above, the function for calculating a squared error is applied, and in the third embodiment, the function for calculating the sum of squared errors is applied, but an error generation function other than these functions may be applied.

In the first, third, and fourth embodiments described above, the learning processing units 78 and 78d calculate a new coefficient to be applied to the neural network 200 by the error backpropagation method, but may calculate a new coefficient to be applied to the neural network 200 by a method other than the error backpropagation method.

The sequence generated by Mersenne twister indicated in the first and third embodiments described above is an example of the training m-value data sequence, and another random sequence having a long cycle capable of suppressing overtraining may be used as the training m-value data sequence.

The learning processing of the neural network 200 indicated in the first and third embodiments described above may be used as a method of estimating a forward transfer function other than estimation of the transfer function of the transmission path 2 in the MLSE and a feature amount extraction method.

In the first to fourth embodiments described above, the possibility symbol sequence input unit 62 may perform preprocessing of performing calculation such as normalization when fetching the possibility symbol sequence {s′ₜ} output by the possibility symbol sequence generation unit 405. For example, the possibility symbol sequence input unit 62 may perform Volterra series expansion on the possibility symbol sequence {s′ₜ} and use the sequence as an input sequence to be given to the DNN unit 61 including a high-order term. However, in this case, since the sequence length of the input sequence is longer than the sequence length p of the possibility symbol sequence {s′ₜ}, the number of input layer nodes 210-1, 210-2, . . . of the neural network 200 included in the DNN unit 61 and the number of taps of the linear adaptive filter unit 61b need to be increased according to the number of input sequences to be given. In this case, it is necessary to similarly increase the number of input layer nodes 210-1, 210-2, . . . of the neural network 200 included in the DNN unit 71 and the number of taps of the linear adaptive filter unit 71b. Therefore, when generating the transmission signal sequence {sₜ} from the training m-value data sequence and generating the input sequence from the generated transmission signal sequence {sₜ}, the input switching units 74 and 74b and the transmission symbol sequence input unit 79 need to perform the same Volterra series expansion as that performed by the possibility symbol sequence input unit 62.

In the first to fourth embodiments described above, the filter update processing unit 35 of the update processing unit 303 of the phase adjustment units 30 and 30e and the filter update processing units 75 and 78b of the optimization units 404 and 404b of the maximum likelihood sequence estimation units 40 and 40b calculate the update values of the tap gain values by the LMS algorithm. On the other hand, instead of the LMS algorithm, another update algorithm such as a recursive least square (RLS) algorithm may be applied.

In the first to fourth embodiments described above, the example in which the Viterbi algorithm is applied in the processing of the maximum likelihood sequence estimation of the determination processing unit 402 is indicated, but a BCJR algorithm may be applied.

The weight selection unit 406 described in the first embodiment may be inserted between the learning processing unit 78d and the DNN unit 71 of the symbol determination unit 6d illustrated in FIG. 17 of the third embodiment described above.

The phase adjustment unit 30 included in the symbol determination unit 6a of the second embodiment described above and the symbol determination unit 6b of the third embodiment illustrated in FIGS. 13 and 14 may be replaced with the phase adjustment unit 30e of the fourth embodiment. The addition average calculation unit 304 of the fourth embodiment may be inserted between the adder 34 of the phase adjustment unit 30c of the symbol determination unit 6c and the low-pass filter unit 401 illustrated in FIG. 16 of the third embodiment.

The delayer 76 included in the symbol determination unit 6 of the first embodiment described above, the symbol determination unit 6b of the third embodiment, and the symbol determination unit 6e of the fourth embodiment fetches the output value output from the low-pass filter unit 401, that is, the determination target reception symbol, and outputs the fetched determination target reception symbol after a time of “wT+(p−1)T/2”, that is, a time of “w+(p−1)/2” symbol has elapsed to the subtractor 77. The reason is that, as described above, for example, in the case of the symbol determination unit 6 of the first embodiment, the position of the estimated transmission symbol aₜ at time t is set to the center position of the input sequence having the sequence length p given to the DNN unit 71. However, the position of the estimated transmission symbol aₜ at time t may not be the center position of the input sequence having the sequence length p given to the DNN unit 71, but may be included in any position of the input sequence having the sequence length p given to the DNN unit 71. Even in this case, the learning processing on the assumption that the estimated transmission symbol aₜ at time t is deviated from the center position of the input sequence having the sequence length p is merely performed, and the DNN unit 71 in the state optimized by the learning processing outputs an output value substantially matching the determination target reception symbol aₜ time t. The fact that the position of the estimated transmission symbol aₜ at time t may not be the center position of the input sequence similarly applies to the symbol determination unit 6b of the third embodiment and the symbol determination unit 6e of the fourth embodiment. Accordingly, the delayer 76 is only required to set any time from “wT” to “wT+(p−1)T/2” as the delay time and output the determination target reception symbol fetched after the delay time has elapsed to the subtractor 77.

The symbol determination unit 6 of the first embodiment, the symbol determination unit 6a of the second embodiment, the symbol determination unit 6b of the third embodiment, and the symbol determination unit 6e of the fourth embodiment described above include the possibility symbol sequence generation unit 405, and the possibility symbol sequence generation unit 405 repeatedly generates “m^{P}” possibility symbol sequences {s′ₜ}. On the other hand, instead of the possibility symbol sequence generation unit 405, a storage unit that stores in advance the “me” possibility symbol sequences {s′ₜ} generated by the possibility symbol sequence generation unit 405 in association with consecutive integer values of 1 to m^{P} may be provided. In this case, the addition comparison selection unit 52, the path tracing determination unit 51, the possibility symbol sequence input unit 62 of the first, third, and fourth embodiments, and the detection processing unit 64 of the second embodiment may include a counter therein, set the initial value of the counter to 1, read the possibility symbol sequence {s′ₜ} corresponding to the value of the counter from the storage unit, and repeat incrementing the value of the counter by 1 after reading. Note that when the value of the counter becomes “m^{P}”, each of the addition comparison selection unit 52, the path tracing determination unit 51, the possibility symbol sequence input unit 62, and the detection processing unit 64 sets the next value of the counter to “1” instead of “m^{P}+1”.

In the configuration of the first embodiment described above, in the processing of steps Sc11, Sc12, and Sc14 illustrated in FIG. 9, the determination processing using an inequality sign with an equality sign is performed. However, the present invention is not limited to the embodiment, and the processing of determining “whether equal to or less than” is merely an example, and may be replaced with processing of determining “whether less than” depending on the way of determining the threshold.

The symbol determination units 6, 6a, 6b, 6c, 6d, and 6e of the first to fourth embodiments described above may be configured as a single symbol determination apparatus.

The symbol determination units 6, 6a, 6b, 6c, 6d, and 6e in the above embodiments may be implemented by a computer. In that case, a program for achieving this function may be recorded in a computer-readable recording medium, and the program recorded in the recording medium may be read and executed by a computer system to achieve this function. Note that the “computer system” mentioned herein includes an OS and hardware such as peripheral equipment. In addition, the “computer-readable recording medium” refers to a portable medium such as a flexible disk, a magneto-optical disk, ROM, or CD-ROM, or a storage apparatus such as a hard disk incorporated in a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing some of the functions described above, may be implemented in a combination of the functions described above and a program already recorded in a computer system, or may be implemented with a programmable logic device such as a field programmable gate array (FPGA).

Although the embodiments of this invention have been described in detail with reference to the drawings, the specific configuration is not limited to the embodiments, and includes design and the like within the scope not departing from the gist of this invention.

### INDUSTRIAL APPLICABILITY

It can be used as a reception-side apparatus in transmission of 400 GbE and 800 GbE.

### REFERENCE SIGNS LIST

6 Symbol determination unit
30 Phase adjustment unit
40 Maximum likelihood sequence estimation unit
301 Adaptive filter unit
302 Provisional determination processing unit
303 Update processing unit
401 Low-pass filter unit
402 Determination processing unit
403 Transmission path estimation unit
404 Optimization unit
405 Possibility symbol sequence generation unit
406 Weight selection unit

1. A symbol determination apparatus comprising:
a possibility symbol sequence generator configured to generate a plurality of possibility symbol sequences that is a possibility for a transmission signal sequence formed by a transmission symbol;
a transmission path estimator configured to include a function approximator that approximates a transfer function of a transmission path that transmits the transmission signal sequence, and outputs an estimated reception symbol obtained as an output of the function approximator when each of a plurality of the possibility symbol sequences is given to the function approximator as an input sequence;
a determination processor configured to specify an estimated transmission symbol corresponding to a determination target reception symbol sequence by determining the transmission symbol by maximum likelihood sequence estimation on a basis of the determination target reception symbol sequence obtained from a reception signal sequence when the transmission path transmits the transmission signal sequence and the estimated reception symbol for each possibility symbol sequence; and
an optimizer configured to optimize the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

2. The symbol determination apparatus according to claim 1, further comprising:
a phase adjuster configured to apply an estimated inverse transfer function that approximates an inverse function of a transfer function of the transmission path to the reception signal sequence to align sampling phases of the reception signal sequence and outputs the reception signal sequence with the aligned sampling phases,
wherein
the determination processor
fetches a symbol sequence of the reception signal sequence with the aligned sampling phases output by the phase adjuster as the determination target reception symbol sequence.

3. The symbol determination apparatus according to claim 2, further comprising:
a low-pass filter configured to suppress a high-frequency component of the reception signal sequence with the aligned sampling phases output by the phase adjuster,
wherein
the determination processor
fetches a symbol sequence of the reception signal sequence with the high-frequency component suppressed by the low-pass filter as the determination target reception symbol sequence.

4. The symbol determination apparatus according to claim 3, further comprising:
a correct answer label storage,
wherein
the optimizer
calculates an optimum filter coefficient for the low-pass filter in a state in which a linear adaptive filter is provided instead of the function approximator,
the phase adjuster
optimizes the estimated inverse transfer function in a state in which the linear adaptive filter is provided instead of the function approximator,
in the correct answer label storage, each determination target reception symbol included in the determination target reception symbol sequence obtained through the phase adjuster in which the estimated inverse transfer function is optimized and the low-pass filter to which the optimum filter coefficient calculated by the optimizer is applied when a predetermined training transmission signal sequence is transmitted is stored as a correct answer label, and
the optimizer
optimizes the function approximator to set a portion of the training transmission signal sequence transmitted when the correct answer label stored in the correct answer label storage is obtained as an input sequence and output the correct answer label corresponding to the input sequence when the input sequence is given.

5. The symbol determination apparatus according to claim 2, wherein
the phase adjuster
outputs a sequence of output values obtained by applying the estimated inverse transfer function to the reception signal sequence as a reception signal sequence with the aligned sampling phases,
or
adds and averages output values obtained by applying the estimated inverse transfer function to the reception signal sequence, and outputs a sequence of addition averaging values obtained by the addition averaging as a reception signal sequence with the aligned sampling phases.

6. The symbol determination apparatus according to claim 1, wherein
the optimizer repeatedly calculates a new coefficient to be applied to the function approximator in a process of optimizing the function approximator, and optimizes the function approximator by applying the calculated new coefficient,
the symbol determination apparatus further comprising:
a weight selector configured to select a weight to be applied to the function approximator on a basis of the weight included in the new coefficient and a predetermined weight threshold before the optimizer applies the new coefficient to the function approximator.

7. A symbol determination method comprising:
generating a plurality of possibility symbol sequences that is a possibility for a transmission signal sequence formed by a transmission symbol;
outputting an estimated reception symbol obtained as an output of a function approximator that approximates a transfer function of a transmission path that transmits the transmission signal sequence when each of a plurality of the possibility symbol sequences generated is given to the function approximator as an input sequence;
specifying an estimated transmission symbol corresponding to a determination target reception symbol sequence by determining the transmission symbol by maximum likelihood sequence estimation on a basis of the determination target reception symbol sequence obtained from a reception signal sequence when the transmission path transmits the transmission signal sequence and the estimated reception symbol for each possibility symbol sequence; and
optimizing the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.

8. A non-transitory storage medium that stores a program for making a computer perform processes, the processes comprising:
generating a plurality of possibility symbol sequences that is a possibility for a transmission signal sequence formed by a transmission symbol;
including a function approximator that approximates a transfer function of a transmission path that transmits the transmission signal sequence, and outputting an estimated reception symbol obtained as an output of the function approximator when each of a plurality of the possibility symbol sequences is given to the function approximator as an input sequence;
specifying an estimated transmission symbol corresponding to a determination target reception symbol sequence by determining the transmission symbol by maximum likelihood sequence estimation on a basis of the determination target reception symbol sequence obtained from a reception signal sequence when the transmission path transmits the transmission signal sequence and the estimated reception symbol for each possibility symbol sequence; and
optimizing the function approximator such that a determination target reception symbol forming the determination target reception symbol sequence is obtained as an output when the transmission signal sequence transmitted when the reception signal sequence is received or a sequence obtained from an estimated transmission signal sequence formed by the estimated transmission symbol is given as an input sequence.
